(19) United States
(12) Patent Application Publication
(10) Pub. No.: US 2002/0029163 A1
(43) Pub. Date: Mar. 7, 2002

(54) Apparatus and method for providing campaign information, campaign-related information and/or election information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 09/939,463

(22) Filed: Aug. 25, 2001

Related U.S. Application Data
(60) Provisional application No. 60/229,979, filed on Sep. 2, 2000.

(51) Int. Cl. G06F 17/60

(52) U.S. Cl. 705/12

(57) ABSTRACT

An apparatus and method for providing campaign information, including a memory device for storing at least one of campaign information and campaign-related information, a receiver for receiving a request for information regarding at least one of a candidate, a campaign and an election, a processor for processing the request for information in conjunction with the at least one of campaign information and campaign-related information, wherein the processor generates an information report in response to the request for information, and a transmitter for transmitting the information report to a communication device associated with an individual.

### RELATED APPLICATIONS

This application claims the benefit of priority of U.S. Provisional Patent Application Serial No. 60/229,979, filed Sep. 2, 2000, and entitled “APPARATUS AND METHOD FOR PROVIDING CAMPAIGN INFORMATION, CAMPAIGN-RELATED INFORMATION AND/OR ELECTION INFORMATION”, the subject matter of which is hereby incorporated by reference herein.

### FIELD OF THE INVENTION

The present invention pertains to an apparatus and method for providing campaign information, campaign-related information, and/or election information and, in particular, to an apparatus and a method for providing campaign information, campaign-related information, and/or election information, which provides information and/or information processing for, or relating to, political campaigns, political elections, public election campaigns, public elections, private elections campaigns, private elections, and/or any other campaigns and/or elections.

### BACKGROUND OF THE INVENTION

Campaigns and elections for various offices are a very important part of our lives and are important to organized societies or other organizations. Campaigns and elections can be very important in that we have the opportunity to select individuals or entities who or which may represent us and/or who or which can be charged with making decisions which can have an enormous impact on us and the way we live our lives.

We experience campaigns and elections for public offices, public officials, public organizations, private organizations, quasi-public organizations, quasi-private organizations, unions, civic associations, student bodies, and the list can go on and on. In many campaigns or elections, the basic premise can be simple. The candidates for the respective offices or positions typically conduct campaigns so as to promote themselves before the voters or the voting electorate. These candidates can distribute materials, literature, purchase advertisements, or commercials, and get out and meet the voters or the voting electorate.

Campaigns and elections, however, present candidates with many obstacles which they must overcome. Campaign laws, rules and regulations, must typically be followed and can be inconvenient and/or burdensome to abide by. Important formal documents, including nominating petitions, financial disclose statements, financial disclosure forms, and/or other documents, may also need to be filed.

Campaigns can typically require the need for various campaign goods, products, and/or services, which may be needed by the candidates or by their respective campaigns in order to conduct an effective campaign. Candidates must also be aware of, and be knowledgeable about, the various issues relating to their respective office(s) or position(s) or the issues facing their prospective constituents.

Access to polls and/or surveys regarding the feelings or sentiments about a candidates) or an issue(s) may also be very important to a candidate, but yet access to these polls or surveys can be very expensive and/or difficult to obtain. Candidates must also have access and/or must obtain a great deal of information regarding the issues related to a campaign or an election as well as a great deal of information in tackling the sometimes rigorous demands of running the campaign itself. Campaign management activities can include determining platforms, designing campaign literature and materials, disseminating campaign materials, conducting fundraising activities, organizing campaign workers, and many other tasks.

There are may other obstacles inherent in running a campaign for elected office. Registered and/or eligible voters typically have to be identified and courted by the candidate, the candidate's campaign, and/or by the political parties and/or organizations who or which support the candidate or issues. Campaigns and elections can also be very expensive to run, thereby making campaign fundraising another important matter for candidates.

Typically, candidates can overcome some of these obstacles with the help of certain contacts and/or connections. This can be easily seen in the cases of incumbents in offices or positions. Incumbents, through their networks and contacts, and by virtue of their office or position, can sometimes tackle the obstacles of campaign better than newcomers, but these efforts can still be met with unnecessary obstacles.

It is submitted that the current state of the art in the running campaigns and/or elections is antiquated at best. There appears to be no system available or in use which can alleviate the obstacles which are faced by candidates for various offices, public and private.

The obstacles which exist, and the shortfalls which are associated with, conducting a campaign or an election can also have a negative impact on the voters, the voting public, the electorate, and our society as a whole. The obstacles faced by candidates in attempting to conduct an informed and effective campaign can leave the voters, the voting public, the electorate, and our society as a whole, uninformed and represented by individuals or organizations who or which may not be the most capable for the office or position at hand.

In short, many shortfalls exist in the current state of conducting campaigns and elections.

### SUMMARY OF THE INVENTION

The present invention overcomes the shortcomings of the prior art and provides an apparatus and a method for providing campaign information, campaign-related information, and/or election information. The present invention pertains to an apparatus and method for providing campaign information, campaign-related information, and/or election information and, in particular, to an apparatus and a method for providing campaign information, campaign-related information, and/or election information, which provides information and/or information processing for, or relating to, political campaigns, political elections, public election campaigns, public elections, private elections campaigns, private elections, and/or any other campaigns and/or elections.

The apparatus and method of the present invention can provide various information as well as provide various information processing routines for providing information and services for and/or related to campaigns, political campaigns, political elections, public election campaigns, public elections, private elections campaigns, private elections, and/or any other campaigns and/or elections.

The apparatus can include a central processing computer or server computer. The central processing computer can provide control over the apparatus and can perform various processing operations for providing the various services described herein. The central processing computer can also provide various services described herein for the various computers associated with users, candidates, election administrators, consultants and/or advisors, polling individuals and/or entities, political parties, mailing products and services providers, advertising products and services providers, literature products and services providers, campaigning products and services providers, fundraisers, scheduling services, lobbyists, special interest groups, and/or financial institutions, who or which utilize the apparatus and method of the present invention.

The central processing computer can be any suitable computer, network computer, or computer system, for providing service for the various individuals and entities who or which utilize the apparatus and method of the present invention and/or any of the respective computers and/or communication devices associated therewith.

The apparatus can also include one or more user computers or user communication devices with each user computer being associated with an individual user or group of users. The user computer can be utilized by any user, individual, candidate, candidate for elective office, campaign manager, campaign aide, constituent, and/or any other third party desiring to utilize the present invention.

The apparatus can also include one or more public election administrator computers or communication devices or public election administrator communication devices with each public election administrator computer being associated with a public election administrator or administrative entity, such as, for example, an elections board for a political subdivision or geographic area, an elections officer, an elections commissioner, and/or any other individual and/or entity who or which oversees and/or administers public elections.

The apparatus can also include one or more private election administrator computers or communication devices or private election administrator communication devices with each private election administrator computer being associated with a private election administrator or administrative entity, such as, for example, a company, a business, a trade association, a professional association, a school, a union, a private organization, a quasi-private organization, civic association, subdivision or geographic area, an elections officer, an elections commissioner, and/or any other individual and/or entity who or which oversees and/or administers private elections.

The apparatus can also include one or more campaign administrator computers or communication devices with each campaign administrator computer being associated with a candidate, campaign manager, staff member, coordinator, and/or other individual and/or entities who or which is involved in the managing of, coordinating, providing support services for, and/or otherwise working for or on, the campaign or campaigns of a candidate and/or a group of candidates for any of the campaigns and/or elective offices and/or positions in conjunction with which the present invention can be utilized.

The apparatus can also include one or more provider computers or communication devices with each provider computer being associated with a provider of any goods, products, and/or services, which can be utilized in any campaigns, campaigning, electioneering, promotional, and/or in any other related activities.

The apparatus can also include one or more media or press computers or communication devices with each media computer being associated with a media service, news service, a print news service, such as, but not limited to, the press, the press media, newspaper, magazine, flier, press service, a television news service, a radio news service, a broadcast service, and/or any other media service, journalistic service, news media service, news service, news bureau, and/or any other media service which can be utilized to provide news information of any kind, as well as receive and/or disseminate news, press releases, and/or any other information, from and/or to, respectively, any of the computers or communication devices described herein as well as any of the parties described herein.

The media computer can provide news related information to the central processing computer 10 as well as any of the other computers or communication devices, described herein as well as any of the parties associated with any of the respective computers or communication devices. The media computer can also receive news information from any of the herein-described parties as well as from other external sources and/or other third parties and/or third party source, which news information can be processed by the media computer and/or by the central processing computer for later dissemination to any of the respective computers or communication devices and/or any of the individuals and/or parties associated therewith.

The apparatus can also include one or more external information source computers or communication devices, with each external information source computer being associated with a external information source. Each external information source computer can also be associated with a number of external information sources, depending upon the desired application. The external information source can be any third party information source, information provider, news service, third party individual, organization, association, civic organization, civic association, union, trade union, event planner, scheduling entity, and/or any other individual and/or entity which may provide information to any of the herein-described individuals and/or entities who or which utilize the present invention.

The apparatus can also include financial institution computers or communication devices with each financial institution computer being associated with a financial institution, a group of financial institutions, and/or any of the individuals and/or entities who or which utilize the present invention. Each financial institution computer can also be associated with a number of candidates, campaigns, individuals and/or entities described herein. The financial institution computer(s) can be utilized in order to manage and/or administer financial accounts for any of individuals and/or entities described herein.

The financial institution computer(s) can also perform financial transactions for, or on behalf of, any of the individuals and/or entities who or which utilize the apparatus and method of the present invention. The financial institution computer(s) can make and/or receive financial payments from any individual or entity for, or on behalf of, any of the individuals and/or entities who or which utilize the present invention.

The central processing computer(s), the user computer(s), the public election administrator computer(s), the private election administrator computer(s), the campaign administrator computer(s), the provider computer(s), the media computer(s), the external information source computer(s), and the financial institution computer(s), can communicate with each other via any suitable communication network or system.

The apparatus can be utilized on, over, and/or in conjunction with, any communication network or system. The apparatus and method of the present invention can also be utilized on, over, and/or in conjunction with, a wireless communication network or system, a wired or line-connected communication network or system, or any combination of a wireless communication network or system and a wired or line-connected communication network or system. The present invention can also utilize wireless Internet and/or World Wide Web services, equipment and/or devices.

The apparatus and method of the present invention can be utilized in a wide variety of manners and/or embodiments in order to provide various processing routines, functions, and/or services.

The present invention can be utilized in order to provide campaign and/or campaigning information to any user of the present invention. The present invention can be utilized for providing information for any type of election and/or campaign, including elections for public office or public offices and/or elections for offices and/or positions in private organizations, quasi-public organizations, and/or quasi-private organizations.

The present invention can also be utilized in order to provide compensation or other rewards for users or voters who view advertisements and/or commercials and/or who participate in surveys or polls.

The apparatus and method of the present invention can also be utilized in order to provide a centralized election and/or campaign information center and/or clearinghouse for information and/or communications regarding and/or occurring between any of the herein-described users, individuals, and/or entities, described herein.

The apparatus and method of the present invention can also be utilized in order to provide campaign management information and/or information for assisting in managing and/or conducting a campaign.

The present invention can also be utilized in order to maintain event schedules and/or calendars for any of the individuals, candidates, campaigns, political parties, and/or organizations, described herein.

The present invention can also be utilized in order to record and store financial transactions for, and/or campaign contributions, financial as well as non-financial and/or in-kind which are received by, an individual, a candidate, a campaign, a political party, and/or organization. The present invention can also be utilized in order to process financial transaction information and/or campaign contribution information in conjunction with financial disclosure requirements and generate financial disclosure report(s) for, or on behalf of, the individual, candidate, campaign, political party, and/or organization.

The present invention can also be utilized in order to provide an information clearinghouse for any or the campaign information and/or election information, and/or any other related information, described herein, which can be utilized in managing and/or conducting campaign activities.

The apparatus and method of the present invention can also be utilized in order to generate, design, and/or produce campaign materials and/or campaign-related materials and disseminate same to a user selected target audience. The present invention can also be utilized in order to provide campaign materials which can include video clips, audio clips, and/or audio/video clips.

The apparatus and method of the present invention can also be utilized in order to perform polling and/or surveys and/or to make the results of the respective polls and/or surveys to any respective users of the present invention.

The apparatus and method of the present invention can be utilized in order to perform targeted information dissemination such as campaign fundraising and targeted fundraising activities.

The apparatus and method of the present invention can be utilized in order to provide notification to an individual, a candidate, a campaign, and/or an organization, of the existence of, and/or the availability of, a provider of campaign goods, campaign products, and/or campaign services, and/or any other campaign-related goods, products, and/or services.

The apparatus and method of the present invention can also be utilized in order to provide notification to a provider(s) of campaign and/or campaign-related goods, products, and/or services, of the existence of a user, an individual, a candidate, a campaign, and/or an organization, who or which may be interested in and/or who or which may be in need of and/or desirous of obtaining and/or utilizing any of the respective goods, products, and/or services, which are provided by the respective provider(s).

The apparatus and method of the present invention can be utilized to conduct a poll, polls, a survey, or surveys, for any of the users, individuals, candidates, campaigns, political parties, and/or organizations. The apparatus and method of the present invention can be programmed to analyze the results of the respective poll, polls, a survey, or surveys, identify areas of weakness or vulnerability, and disseminate campaign materials to targeted voters or areas in order to attempt to overcome the weakness or vulnerability.

The apparatus of the present invention can also be programmed to perform campaign and/or campaigning functions or tasks for, or on behalf of, the respective users, individuals, candidates, campaigns, political party or political parties, and/or organizations, described herein.

The apparatus and method of the present invention can be utilized in order to bid for, and/or to auction off, any of the campaign and/or campaign-related goods, products, and/or services, described herein, and/or any other goods, products, and/or services, which can be utilized in a campaign and/or in an election. The apparatus and method of the present invention can also be utilized in order to provide recruitment services and/or to facilitate recruitment activities for, or regarding, any campaign and/or campaign-related positions and/or jobs.

The apparatus and method of the present invention can also be utilized in order to administer and/or manage financial accounts, and/or to transmit and/or receive payments and/or funds transfer, for, or on behalf of, any of the candidates, campaigns, providers, organizations, and/or any other users, of the present invention.

The apparatus and method of the present invention can also be utilized in order to perform on-line voting in any of the herein-described elections and/or campaigns.

The apparatus of the present invention can also be utilized in order to receive campaign contributions and/or campaign donations for, or on behalf of any of the candidates, campaigns, political parties, and/or organizations, described herein.

The apparatus and method of the present invention can also be utilized in order to monitor the activities of registered voters and/or eligible voters during an election. The apparatus can also be utilized in order to monitor the individuals who have voted, determine and/or identity the individuals who have not yet voted, and transmit a message or other communication to these individuals.

The apparatus and method of the present invention can also be utilized as a clearinghouse for buying and selling campaign goods, campaign products, campaign services, campaign-related goods, campaign-related products, and/or campaign-related services.

The apparatus and method of the present invention can utilize intelligent agents, software agents, and/or mobile agents in order to perform any tasks, operations, and/or functions, for, or on behalf of, any of the individuals and/or entities who or which utilize the present invention.

The present invention can be utilized in conjunction with various security and cryptography technologies and/or techniques so as to provide for security and confidentiality for or regarding any and/or all of the communications, as well as any of the data and/or information transmissions, which are described as occurring between any of the herein-described users, individuals, candidates, campaigns, administrators, providers, external information sources, and/or financial institutions, or the respective computers or communication devices associated therewith.

Accordingly, it is an object of the present invention to provide an apparatus and method for providing campaign information, campaign-related information, and/or election information.

It is another object of the present invention to provide an apparatus and method for providing campaign information, campaign-related information, and/or election information, in a network environment.

It is still another object of the present invention to provide an apparatus and method for providing campaign information and/or campaign-related information which provides information and/or information processing for, or relating to, any campaign and/or election.

It is yet another object of the present invention to provide an apparatus and method for providing campaign information and/or campaign-related information which provides information and/or information processing for, or relating to, political campaigns, political elections, public election campaigns, public elections, private elections campaigns, private elections, and/or any other campaigns and/or elections.

It is another object of the present invention to provide an apparatus and method for providing campaign information and/or campaign-related information which provides for any type or kind of campaign and/or election.

It is still another object of the present invention to provide an apparatus and method for providing campaign information and/or campaign-related information which can provide information regarding a candidate or candidates.

It is yet another object of the present invention to provide an apparatus and method for providing campaign information and/or campaign-related information which can be utilized to provide information regarding and/or concerning elections, offices, positions, candidates, and/or campaigns.

It is another object of the present invention to provide an apparatus and method for providing campaign information and/or campaign-related information which can be utilized in order to provide compensation and/or rewards to the viewer of advertisements and/or commercials.

It is still another object of the present invention to provide an apparatus and method for providing campaign information and/or campaign-related information which can be utilized in order to provide compensation and/or rewards to an individual and/or entity who or which participates in a poll or survey.

It is yet another object of the present invention to provide an apparatus and method for providing campaign information and/or campaign-related information which can be utilized in order to perform tasks for, or on behalf of, an individual or entity.

It is another object of the present invention to provide an apparatus and method for providing campaign information and/or campaign-related information which can be utilized in order to provide notification to an individual or entity regarding the posting of information regarding a campaign, an election, an office or position, or a candidate or candidates.

It is still another object of the present invention to provide an apparatus and method for providing campaign information and/or campaign-related information which can be utilized in order to provide a centralized election and/or campaign information center and/or clearinghouse for information and/or communications.

It is yet another object of the present invention to provide an apparatus and method for providing campaign information and/or campaign-related information which can be utilized in order to provide campaign management information and/or information for assisting in managing and/or conducting a campaign.

It is another object of the present invention to provide an apparatus and method for providing campaign information and/or campaign-related information which can be utilized in order to provide campaign management information and/or information for assisting in managing and/or conducting a campaign, which can provide menu-based information.

It is still another object of the present invention to provide an apparatus and method for providing campaign information and/or campaign-related information which can be utilized in order to provide poll information and/or survey information.

It is still another object of the present invention to provide an apparatus and method for providing campaign information and/or campaign-related information which can be utilized in order to provide information regarding a candidate's standing in a poll or survey.

It is yet another object of the present invention to provide an apparatus and method for providing campaign information and/or campaign-related information which can be utilized in order to perform polls and/or surveys.

It is another object of the present invention to provide an apparatus and method for providing campaign information and/or campaign-related information which can be programmed to perform polls, poll taking, and/or surveys.

It is still another object of the present invention to provide an apparatus and method for providing campaign information and/or campaign-related information which can be programmed to perform polls, poll taking, and/or surveys, at any time, at a pre-determined time interval(s), and/or in any other appropriate and/or selected manner.

It is yet another object of the present invention to provide an apparatus and method for providing campaign information and/or campaign-related information which can perform polls or surveys for a candidate and/or for any issues or areas of interest.

It is another object of the present invention to provide an apparatus and method for providing campaign information and/or campaign-related information which can be utilized to process event scheduling information.

It is still another object of the present invention to provide an apparatus and method for providing campaign information and/or campaign-related information which can be utilized in order to record and store financial transactions.

It is yet another object of the present invention to provide an apparatus and method for providing campaign information and/or campaign-related information which can be utilized to process information regarding campaign contributions.

It is still another object of the present invention to provide an apparatus and method for providing campaign information and/or campaign-related information which can generate a financial disclosure report(s) for, or on behalf of, an individual and/or entity.

It is yet another object of the present invention to provide an apparatus and method for providing campaign information and/or campaign-related information which can file a financial disclosure report(s) for, or on behalf of, an individual and/or entity.

It is another object of the present invention to provide an apparatus and method for providing campaign information and/or campaign-related information which can be utilized in order to design, generate, produce, or disseminate, campaign materials, campaign literature, and/or press releases.

It is still another object of the present invention to provide an apparatus and method for providing campaign information and/or campaign-related information which can be utilized in order to design, generate, produce, or disseminate, campaign materials, campaign literature, and/or press releases which can include any one or more of text materials, audio materials, video materials, audio/video materials, and/or any combination thereof.

It is yet another object of the present invention to provide an apparatus and method for providing campaign information and/or campaign-related information which can be utilized

It is another object of the present invention to provide an apparatus and method for providing campaign information and/or campaign-related information which can be utilized to disseminate campaign information, materials, and/or literature to a target audience.

It is still another object of the present invention to provide an apparatus and method for providing campaign information and/or campaign-related information which can be utilized in order to provide campaign materials which can include video clips, audio clips, and/or audio/video clips.

It is still another object of the present invention to provide an apparatus and method for providing campaign information and/or campaign-related information which can be utilized in order to perform polling and/or surveys.

It is yet another object of the present invention to provide an apparatus and method for providing campaign information and/or campaign-related information which can be utilized in order to perform polling and/or surveys, and to provide the results of polls or surveys to interested individuals or entities.

It is another object of the present invention to provide an apparatus and method for providing campaign information and/or campaign-related information which can be utilized in order to generate a poll or survey.

It is still another object of the present invention to provide an apparatus and method for providing campaign information and/or campaign-related information which can be utilized in order to perform targeted campaign fundraising efforts.

It is yet another object of the present invention to provide an apparatus and method for providing campaign information and/or campaign-related information which can be utilized in order to provide notification to an individual, a candidate, a campaign, and/or an organization, of the existence of, and/or the availability of, a provider of campaign goods, campaign products, and/or campaign services.

It is another object of the present invention to provide an apparatus and method for providing campaign information and/or campaign-related information which can be utilized in order to identify and/or to locate providers of campaign goods, campaign products, and/or campaign services.

It is still another object of the present invention to provide an apparatus and method for providing campaign information and/or campaign-related information which can be utilized in order to provide notification to a provider(s) of campaign and/or campaign-related goods, products, and/or services, of the existence of a user, an individual, a candidate, a campaign, and/or an organization, who or which may be interested in and/or who or which may be in need of and/or desirous of obtaining and/or utilizing any of the respective goods, products, and/or services, which are provided by the respective provider(s).

It is yet another object of the present invention to provide an apparatus and method for providing campaign information and/or campaign-related information which can be utilized in order to conduct a poll, polls, a survey, or surveys, for any of the users, individuals, candidates, campaigns, political parties, and/or organizations, described herein.

It is another object of the present invention to provide an apparatus and method for providing campaign information and/or campaign-related information which can be programmed to analyze the results of the a poll, polls, a survey, or surveys.

It is yet another object of the present invention to provide an apparatus and method for providing campaign information and/or campaign-related information which can be programmed to identify areas of weakness or vulnerability.

It is another object of the present invention to provide an apparatus and method for providing campaign information and/or campaign-related information which can be programmed to disseminate campaign materials to targeted voters or areas.

It is still another object of the present invention to provide an apparatus and method for providing campaign information and/or campaign-related information which can be programmed to perform campaign activities and/or campaigning-related activities.

It is yet another object of the present invention to provide an apparatus and method for providing campaign information and/or campaign-related information which can be utilized in order to provide notification of the results of a poll, polls, survey, and/or surveys.

It is another object of the present invention to provide an apparatus and method for providing campaign information and/or campaign-related information which can perform campaign, and/or programmed campaigning, functions or tasks for, or on behalf of, a respective user, individual, candidate, campaign, political party, and/or organization.

It is still another object of the present invention to provide an apparatus and method for providing campaign information and/or campaign-related information which can be utilized in order to bid for, and/or to auction off, campaign and/or campaign-related goods, products, and/or services.

It is yet another object of the present invention to provide an apparatus and method for providing campaign information and/or campaign-related information which can be utilized in order to provide recruitment services and/or recruitment activities.

It is another object of the present invention to provide an apparatus and method for providing campaign information and/or campaign-related information which can be utilized in order to administer and/or manage financial accounts.

It is still another object of the present invention to provide an apparatus and method for providing campaign information and/or campaign-related information which can be utilized in order to transmit and/or receive payments and/or funds transfer, for, or on behalf of, any respective party or parties.

It is yet another object of the present invention to provide an apparatus and method for providing campaign information and/or campaign-related information which can be utilized in order to perform on-line voting and/or on-line elections.

It is another object of the present invention to provide an apparatus and method for providing campaign information and/or campaign-related information which can be utilized in order to receive campaign contributions and/or campaign donations for, or on behalf of, a respective party or parties.

It is still another object of the present invention to provide an apparatus and method for providing campaign information and/or campaign-related information which can be utilized in order to monitor the activities of registered voters and/or eligible voters during an election.

It is yet another object of the present invention to provide an apparatus and method for providing campaign information and/or campaign-related information which can be programmed to promote voting in an election.

It is another object of the present invention to provide an apparatus and method for providing campaign information and/or campaign-related information which can be programmed to promote voting for a candidate or an issue.

It is still another object of the present invention to provide an apparatus and method for providing campaign information and/or campaign-related information which can be utilized as a clearinghouse for buying or selling campaign goods, campaign products, campaign services, campaign-related goods, campaign-related products, and/or campaign-related services.

It is yet another object of the present invention to provide an apparatus and method for providing campaign information and/or campaign-related information which can utilize intelligent agents, software agents, and/or mobile agents.

It is another object of the present invention to provide an apparatus and method for providing campaign information and/or campaign-related information which can be programmed to be self-activating and/or activated automatically.

It is still another object of the present invention to provide an apparatus and method for providing campaign information and/or campaign-related information which can utilize electronic commerce technologies and security methods, techniques and technologies.

It is yet another object of the present invention to provide an apparatus and method for providing campaign information and/or campaign-related information which can utilize security and cryptography technologies and/or techniques.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates the user computer of FIG. 1, in block diagram form;

FIG. 4 illustrates the public election administrator computer of FIG. 1, in block diagram form;

FIG. 5 illustrates the private election administrator computer of FIG. 1, in block diagram form;

FIG. 6 illustrates the campaign administrator computer of FIG. 1, in block diagram form;

FIG. 7 illustrates provider computer of FIG. 1, in block diagram form;

FIG. 8 illustrates media computer of FIG. 1, in block diagram form;

FIG. 9 illustrates external information source computer of FIG. 1, in block diagram form;

FIG. 10 illustrates financial institution computer of FIG. 1, in block diagram form;

FIGS. 11A and 11B illustrate a preferred embodiment method for utilizing the present invention, in flow diagram form;

FIGS. 12A and 12B illustrate another preferred embodiment method for utilizing the present invention, in flow diagram form;

FIGS. 13A and 13B illustrates another preferred embodiment method for utilizing the present invention, in flow diagram form;

FIG. 14 illustrates still another preferred embodiment method for utilizing the present invention, in flow diagram form;

FIGS. 15A and 15B illustrate yet another preferred embodiment method for utilizing the present invention, in flow diagram form;

FIG. 16 illustrates another preferred embodiment method for utilizing the present invention, in flow diagram form;

FIG. 17 illustrates still another preferred embodiment method for utilizing the present invention, in flow diagram form; and

FIGS. 18A and 18B illustrate still another preferred embodiment method for utilizing the present invention, in flow diagram form.

### DESCRIPTION OF THE PREFERRED EMBODIMENTS

The present invention pertains to an apparatus and method for providing campaign information, campaign-related information, and/or election information and, in particular, to an apparatus and a method for providing campaign information, campaign-related information, and/or election information, which provides information and/or information processing for, or relating to, political campaigns, political elections, public election campaigns, public elections, private elections campaigns, private elections, and/or any other campaigns and/or elections.

The apparatus and method of the present invention can provide various information as well as provide various information processing routines for providing information and services for and/or related to campaigns, political campaigns, political elections, public election campaigns, public elections, private elections campaigns, private elections, and/or any other campaigns and/or elections.

Applicant hereby incorporates by reference herein the subject matter and teachings of U.S. Provisional Patent Application Serial No. 60/229,979 which teaches and discloses an apparatus and method for providing campaign information, campaign-related information and/or election information.

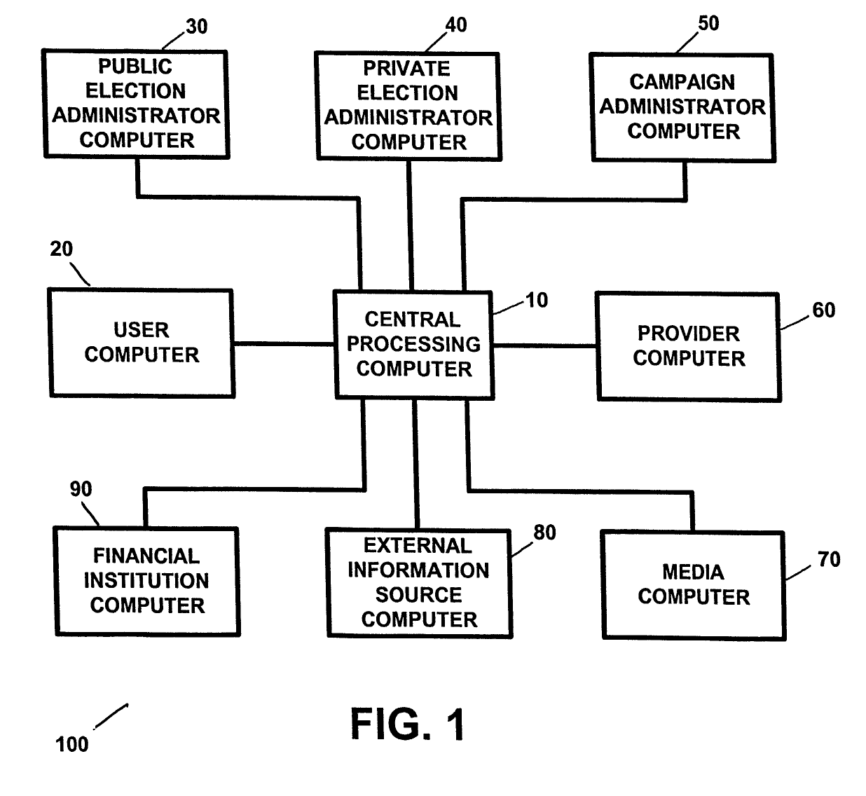

FIG. 1 illustrates the apparatus of the present invention which is designated by the reference numeral 100, in block diagram form. With reference to FIG. 1, the apparatus 100 includes a central processing computer or server computer 10 (hereinafter referred to as “central processing computer 10”).

The central processing computer 10 provides control over the apparatus 100 and performs various processing operations for providing the various services described herein. The central processing computer 10 also provides various services described herein for the various computers or communication devices associated with users, candidates, election administrators, consultants and/or advisors, polling individuals and/or entities, political parties, mailing products and services providers, advertising products and services providers, literature products and services providers, campaigning products and services providers, fundraisers, scheduling services, lobbyists, special interest groups, and/or financial institutions, who or which utilize the apparatus 100 and method of the present invention.

The central processing computer 10, in the preferred embodiment, can be any suitable computer, network computer, or computer system, for providing service for the various individuals and entities who or which utilize the apparatus and method of the present invention and/or any of the respective computers and/or communication devices associated therewith.

In the preferred embodiment, any number of central processing computers 10 can be utilized in order to provide the processing and/or servicing functions described herein. The central processing computers) 10 may be linked to other central processing computers or may be stand alone devices.

Each central processing computer 10 may be a network computer, a personal computer, and/or any other communication device, suitable for allowing the central processing computer 10 to communicate with and/or to interact with any other central processing computer(s) 10 and/or with any of the other computers or communication devices described herein.

A given central processing computer 10 may service a particular geographic area, a particular political area or sub-division, a private organization or group of organizations, and/or any other individuals, groups of individuals, entity or group of entities. A central processing computer 10 can also be utilized by a political party, a union or other organization, and/or any other entity and/or group of individuals.

A central processing computer 10 may also be dedicated to service any one or group of the above described individuals and/or entities.

The apparatus 100, in the preferred embodiment, also includes one or more user computers or user communication devices 20 (hereinafter referred to as “user computer 20” or “user computers 20”) with each user computer 20 being associated with an user, individual, or group of users or individuals. Any user computer 20 may also be associated with a number of users and/or individuals, depending upon the application. The user computer 20 can be utilized by any individual, candidate, candidate for elective office, campaign manager, campaign aide, constituent, and/or any other third party desiring to utilize the apparatus 100.

Each user computer 20 may be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the user computer 20 to communicate with and/or to interact with the central processing computer(s) 10 and/or any of the other computers or communication devices described herein. Each user computer 20 can be utilized to transmit information to the central processing computer 10 and to receive information from the central processing computer 10 via the communication network.

In the present invention, any number of user computers 20 may be utilized. In the present invention, each individual or entity utilizing the present invention may have one or more user computers 20 associated therewith.

The apparatus 100, in the preferred embodiment, also includes one or more public election administrator computers 30 or public election administrator communication devices 30 (hereinafter referred to as “public election administrator computer 30” or “public election administrator computers 30”) with each public election administrator computer 30 being associated with a public election administrator or administrative entity, such as, for example, an elections board for a political subdivision or geographic area, an elections officer, an elections commissioner, and/or any other individual and/or entity who or which oversees and/or administers public elections.

A public election administrator computer 30 can be associated with and/or can be utilized by any elections administrator, elections commission, elections administrator, elections commissioner and/or the commissioner's aides, administrative board, board of elections, and/or and other individual and/or entity that oversees, administers, monitors, elections for public offices and/or any other public elections.

Each public election administrator computer 30 can also be associated with a number of public elections boards, administrators, elections commissions, and/or any other elections administrators, depending upon the application.

Each public election administrator computer 30 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing the public election administrator computer 30 to communicate with and/or to interact with the central processing computers) 10 and/or any of the other computers described herein. Each public election administrator computer 30 can be utilized to transmit information to the central processing computer 10 and to receive information from the central processing computer 10 via the communication network.

In the preferred embodiment, any number of public election administrator computers 30 may be utilized. In the present invention, each elections administrator, elections commission, elections administrator, elections commissioner and/or the commissioner's aides, administrative board, board of elections, and/or and other individual and/or entity that oversees, administers, monitors, elections for public offices and/or any other public elections, utilizing the present invention may have one or more public election administrator computer 30 associated therewith.

The apparatus 100, in the preferred embodiment, also includes one or more private election administrator computers or communication devices 40 (hereinafter referred to as “private election administrator computer 40” or “private election administrator computers 40”) with each private election administrator computer 40 being associated with a private election administrator or administrative entity, such as, for example, a company, a business, a trade association, a professional association, a school, a union, a private organization, a quasi-private organization, civic association, subdivision or geographic area, an elections officer, an elections commissioner, and/or any other individual and/or entity who or which oversees and/or administers private elections.

A private election administrator computer 40 can be associated with and/or can be utilized by any elections administrator, elections commission, elections commissioner and/or the commissioner's aides, administrative board, board of elections, and/or and other individual and/or entity that oversees, administers, monitors, elections for private offices and/or any other private elections.

Each private election administrator computer 40 can also be associated with any number of a companies, businesses, trade associations, political action committees, professional associations, political action committees, schools, unions, private organizations, quasi-private organizations, civic associations, subdivisions or geographic areas, elections officers, elections commissioners, and/or any other individuals and/or entities who or which oversee and/or administer private elections and/or private or quasi-private organization elections.

Each private election administrator computer 40 can be a personal computer, a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, a network computer, a server computer, and/or any other communication device, suitable for allowing the private election administrator computer 40 to communicate with and/or to interact with the central processing computer(s) 10 and/or any of the other computers or communication devices, described herein. Each private election administrator computer 40 can be utilized to transmit information to the central processing computer 10 and to receive information from the central processing computer 10 via the communication network.

In the preferred embodiment, any number of private election administrator computers 40 can be utilized. In the present invention, each elections administrator, elections commission, elections administrator, elections commissioner and/or the commissioner's aides, administrative board, board of elections, and/or and other individual and/or entity that oversees, administers, monitors, elections for private offices and/or any other private or quasi-private elections, utilizing the present invention can have one or more private election administrator computers 40 associated therewith.

The apparatus 100, in the preferred embodiment, also includes one or more campaign administrator computers or communication devices 50 (hereinafter referred to as “campaign administrator computer 50” or “campaign administrator computers 50”) with each campaign administrator computer 50 being associated with a candidate, campaign manager, staff member, coordinator, and/or other individual and/or entities who or which is involved in the managing of, coordinating, providing support services for, and/or otherwise working for or on, the campaign or campaigns of a candidate and/or a group of candidates for any of the campaigns and/or elective offices and/or positions in conjunction with which the present invention can be utilized.

A campaign administrator computer 50 can be associated with and/or can be utilized by any candidate, campaign manager, staff member, coordinator, and/or other individual and/or entities who or which is involved in the managing of, coordinating, providing support services for, and/or otherwise working for or on, the campaign or campaigns of a candidate and/or a group of candidates.

Each campaign administrator computer 50 can also be associated with any number of candidates, campaign managers, staff members, coordinators, and/or other individuals and/or entities who or which is involved in the managing of, coordinating, providing support services for, and/or otherwise working for or on, the campaign or campaigns of a candidate and/or a group of candidates.

Each campaign administrator computer 50 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, a network computer, a server computer, and/or any other communication device, suitable for allowing candidate, campaign manager, staff member, coordinator, and/or other individual and/or entities who or which is involved in the managing of, coordinating, providing support services for, and/or otherwise working for or on, the campaign or campaigns of a candidate and/or a group of candidates, to communicate with and/or to interact with the central processing computer(s) 10 and/or any of the other computers, described herein.

Each campaign administrator computer 50 can be utilized to transmit information to the central processing computer 10 and to receive information from the central processing computer 10 via the communication network.

In the preferred embodiment, any number of campaign administrator computers 50 can be utilized. In the present invention, each a candidate, campaign manager, staff member, coordinator, and/or other individual and/or entities who or which is involved in the managing of, coordinating, providing support services for, and/or otherwise working for or on, the campaign or campaigns of a candidate and/or a group of candidates for any of the campaigns and/or elective offices and/or positions in conjunction with which the present invention can be utilized, utilizing the present invention can have one or more campaign administrator computer 50 associated therewith.

The apparatus 100, in the preferred embodiment, also includes one or more provider computers or communication devices 60 (hereinafter referred to as “provider computer 60” or “provider computers 60”) with each provider computer 60 being associated with a provider of any goods, products, and/or services, which can be utilized in any campaigns, campaigning, electioneering, promotional, and/or in any other related activities.

The providers can be any goods providers, products providers, services providers, campaign consultants, political consultants, campaign advisors, political advisors, and/or any other individual, individuals, entity, and/or entities, who or which provide campaign-related and/or election-related goods and/or products, such as, but not limited to, buttons, bumper stickers, literature, palm cards, advertisements, business cars, balloons, posters, signs, pens, pencils, and any other campaign-related goods and/or products and/or election-related goods and/or products, and/or who or which provide campaign-related and/or election-related services, such as, but not limited to, campaign management services, campaign consulting services, campaign advisory services, campaigning services, petition gathering services, printing services, publicity services, promotional services, advertising services, fundraising services, accounting services, legal services, staffing services, and/or any other campaign-related services and/or election-related services.

A provider computer 60 can be associated with and/or can be utilized by any provider of any of the herein-described campaign, campaign-related, election, and/or election-related, goods, products, and/or services.

Each provider computer 60 can also be associated with any number of the herein-described providers.

Each provider computer 60 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing a provider or group of providers to communicate with and/or to interact with the central processing computer(s) 10 and/or any of the other computers, described herein.

Each provider computer 60 can be utilized to transmit information to the central processing computer 10 and to receive information from the central processing computer 10 via the communication network.

In the preferred embodiment, any number of provider computers 60 can be utilized. In the present invention, each provider utilizing the present invention can have one or more provider computers 60 associated therewith.

The apparatus 100, in the preferred embodiment, also includes one or more media or press computers or communication devices 70 (hereinafter referred to as “media computer 70” or “media computers 70”) with each media computer 70 being associated with a media service, news service, a print news service, such as, but not limited to, the press, the press media, newspaper, magazine, flier, press service, a television news service, a radio news service, a broadcast service, and/or any other media service, journalistic service, news media service, news service, news bureau, and/or any other media service which can be utilized to provide news information of any kind, as well as receive and/or disseminate news, press releases, and/or any other information, from and/or to, respectively, any of the computers or communication devices described herein as well as any of the parties described herein.

The media computer 70 can provide news related information to the central processing computer 10 as well as any of the other computers, described herein as well as any of the parties associated with any of the respective computers. The media computer can also receive news information from any of the herein-described parties as well as from other external sources and/or other third parties and/or third party source, which news information can be processed by the media computer 70 and/or by the central processing computer 10 for later dissemination to any of the respective computers and/or any of the individuals and/or parties associated therewith.

A media computer 70 can be associated with any media service, news service, a print news service, such as, but not limited to, the press, the press media, newspaper, magazine, flier, press service, a television news service, a radio news service, a broadcast service, and/or any other media service, journalistic service, news media service, news service, news bureau, and/or any other media service, descried herein.

Each media computer 70 can also be associated with any media service, news service, a print news service, such as, but not limited to, the press, the press media, newspaper, magazine, flier, press service, a television news service, a radio news service, a broadcast service, and/or any other media service, journalistic service, news media service, news service, news bureau, and/or any other media service.

Each media computer 70 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing any of the news information services and/or media services, described herein, to communicate with and/or to interact with the central processing computer(s) 10 and/or any of the other computers described herein.

Each media computer 70 can be utilized to transmit information to the central processing computer 10 and to receive information from the central processing computer 10 via the communication network.

In the preferred embodiment, any number of media computers 70 can be utilized. In the present invention, each media service utilizing the present invention can have one or more media computers 70 associated therewith.

The apparatus 100, in the preferred embodiment, also includes one or more external information source computers or communication devices 80 (hereinafter referred to as “external information source computer 80” or “external information source computers 80”), with each external information source computer 80 being associated with a external information source. Each external information source computer 80 can also be associated with a number of external information sources, depending upon the desired application.

The external information source can be any third party information source, information provider, news service, third party individual, organization, association, civic organization, civic association, union, trade union, event planner, scheduling entity, and/or any other individual and/or entity which may provide information to any of the herein-described individuals and/or entities who or which utilize the present invention.

Each external information source computer 80 may be a can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing any of the external information sources, described herein, to communicate with and/or to interact with the central processing computer(s) 10 and/or any of the other computers described herein.

Each external information source computer 80 can be utilized to transmit information to the central processing computer 10 and to receive information from the central processing computer 10 and/or any of the other computers described herein via the communication network.

In the preferred embodiment, any number of external information source computers 80 may be utilized. In the present invention, each external information source utilizing, and/or providing information to, the present invention may have one or more external information source computers 80 associated therewith.

The apparatus 100, in the preferred embodiment, also includes one or more financial institution computers or communication devices 90 (hereinafter referred to as “financial institution computer 90” or “financial institution computers 90”), with each financial institution computer 90 being associated with a financial institution, a group of financial institutions, and/or any of the individuals and/or entities who or which utilize the present invention.

Each financial institution computer 90 can also be associated with a number of candidates, campaigns, individuals and/or entities described herein. The financial institution computer(s) 90 can be utilized in order to manage and/or administer financial accounts for any of individuals and/or entities described herein. The financial institution computer(s) 90 can also perform financial transactions for, or on behalf of, any of the individuals and/or entities who or which utilize the apparatus 100 and method of the present invention. The financial institution computer(s) 90 can make and/or receive financial payments from any individual or entity for, or on behalf of, any of the individuals and/or entities who or which utilize the present invention.

The financial institution computer(s) 90 can be dedicated to any individual and/or entity, and/or any group of individuals and/or entities. The financial institution computer(s) 90 can also be associated with public banking institutions and/or private banking and/or financial institutions.

Each financial institution computer 90 can be a personal computer, a hand-held computer, a palmtop computer, a laptop computer, a personal communication device, a personal digital assistant, a telephone, a digital telephone, a display telephone, a video telephone, a videophone, a 3G telephone, a cellular telephone, a wireless telephone, a television, an interactive television, a beeper, a pager, a watch, a network computer, a server computer, and/or any other communication device, suitable for allowing any of the external information sources, described herein, to communicate with and/or to interact with the central processing computer(s) 10 and/or any of the other computers described herein. Each financial institution computer 90 can be utilized to communicate with and/or to interact with the central processing computer 10 and/or any of the other computers described herein via the communication network.

In the preferred embodiment, any number of financial institution computers 90 may be utilized. In the present invention, each financial institution, individual and/or entity may have one or more financial institution computer 90 associated therewith.

The terms “operator”, “user”, or the plural versions of same, as defined herein, can refer to any individual and/or entity who or which utilizes and/or operates any of the central processing computers 10, the user computers 20, public election administrator computers 30, private election administrator computers 40, campaign administrator computers 50, provider computers 60, media computers 70, external information source computers 80, and/or financial institution computers 90, described herein, and/or who or which utilize the apparatus 100 or any of its component computers in order to perform any of the processing functions and/or routines described herein.

Each of the central processing computer(s) 10, the user computer(s) 20, the public election administrator computer(s) 30, the private election administrator computer(s) 40, the campaign administrator computer(s) 50, the provider computer(s) 60, the media computer(s) 70, the external information source computer(s) 80, and the financial institution computer(s) 90, can communicate and/or interact with any central processing computer(s) 10 and/or any other user computer(s) 20, public election administrator computer(s) 30, private election administrator computer(s) 40, campaign administrator computer(s) 50, provider computer(s) 60, media computer(s) 70, external information source computer(s) 80, and/or financial institution computer(s) 90.

The central processing computer(s) 10, the user computer(s) 20, the public election administrator computer(s) 30, the private election administrator computer(s) 40, the campaign administrator computer(s) 50, the provider computer(s) 60, the media computer(s) 70, the external information source computer(s) 80, and the financial institution computer(s) 90, can communicate with each other via any suitable communication network or system.

In the preferred embodiment, the apparatus 100 can be utilized on, over, or in conjunction with, the Internet and/or the World Wide Web. The apparatus 100 can also be utilized on, over, or in conjunction with, any appropriate communication networks or systems including, but not limited to, network communication systems, telephone communication networks or systems, wired or line connected communication networks or systems, wireless communications networks or systems, cellular communication networks or systems, digital communication networks or systems, personal communication networks or systems, personal communication services (PCS) networks or systems, satellite communication networks or systems, broad band communication networks or systems, bluetooth communications networks or systems, low earth orbiting (LEO) satellite networks or systems, and/or public switched telephone networks or systems.

The apparatus and method of the present invention can be utilized on, over, and/or in conjunction with, a wireless communication network or system, a wired or line-connected communication network or system, or any combination of a wireless communication network or system and a wired or line-connected communication network or system.

The present invention, in the preferred embodiment, can also utilize wireless Internet and/or World Wide Web services, equipment and/or devices. The central processing computer(s) 10, in the preferred embodiment, has a web site or web sites associated therewith. Any of the user computers 20, public election administrator computers 30, private election administrator computers 40, campaign administrator computers 50, provider computers 60, media computers 70, external information source computers 80, and/or financial institution computers 90, can also have a web site(s) or web page(s) associated therewith.

In the preferred embodiment, each of the central processing computer(s) 10, the user computer(s) 20, the public election administrator computer(s) 30, the private election administrator computer(s) 40, the campaign administrator computer(s) 50, the provider computer(s) 60, the media computer(s) 70, the external information source computer(s) 80, and/or the financial institution computer(s) 90, can be equipped with any and/or all hardware and/or software necessary and/or desirable for facilitating the operation of the apparatus 100 as described herein.

In the preferred embodiment, each of the central processing computer(s) 10, the user computer(s) 20, the public election administrator computer(s) 30, the private election administrator computer(s) 40, the campaign administrator computer(s) 50, the provider computer(s) 60, the media computer(s) 70, the external information source computer(s) 80, and/or the financial institution computer(s) 90, can transmit and/or receive data and/or information using TCP/IP, as well as any other Internet and/or World Wide Web, protocols.

The central processing computer(s) 10, the user computer(s) 20, the public election administrator computer(s) 30, the private election administrator computer(s) 40, the campaign administrator computer(s) 50, the provider computer(s) 60, the media computer(s) 70, the external information source computer(s) 80, and/or the financial institution computer(s) 90, in the preferred embodiment, can be linked directly or indirectly with any other central processing computer(s) 10, the user computer(s) 20, the public election administrator computer(s) 30, the private election administrator computer(s) 40, the campaign administrator computer(s) 50, the provider computer(s) 60, the media computer(s) 70, the external information source computer(s) 80, and/or the financial institution computer(s) 90. Any of the herein-described computers may communicate with any other computer in a bi-directional manner.

In any and/or all of the embodiments described herein, any of the computer to computer communications, and/or any of the communications which can occur between any of the herein-described individuals and/or entities and/or their respective computers, can be made and/or can be effected by an e-mail transmission, an e-mail message, an electronic transmission, a telephone message, a letter mail delivery, a telephone transmission, a facsimile transmission, a beeper or a pager message, and/or via any other notification means or method.

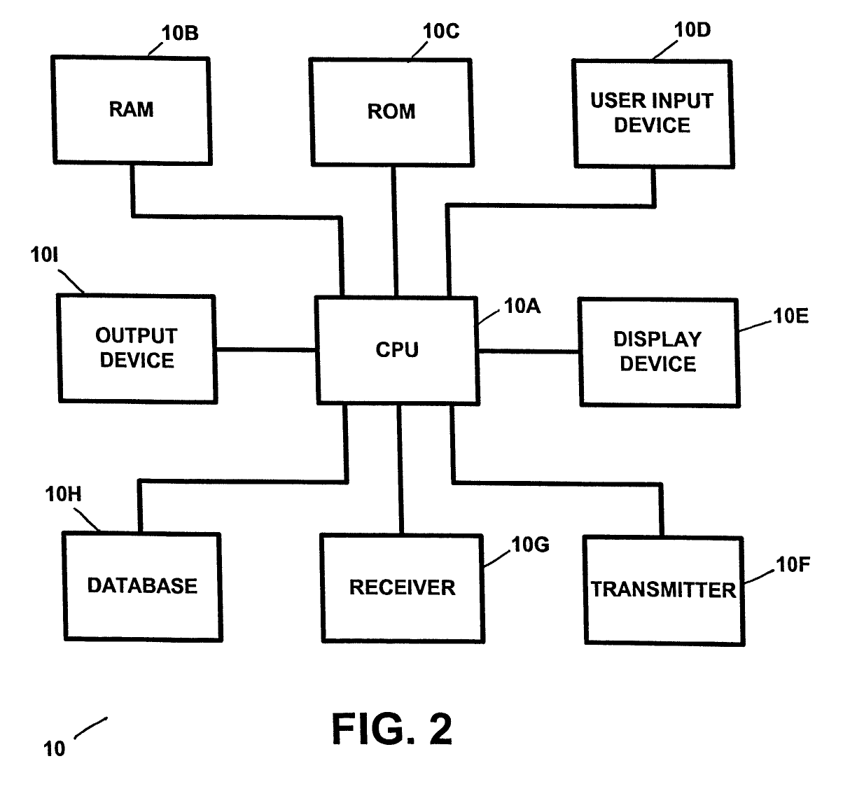

FIG. 2 illustrates the central processing computer 10, in block diagram form. The central processing computer 10, in the preferred embodiment, is a network computer or computer system which is utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) is also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention. The central processing computer 10 also includes a receiver 10G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The central processing computer 10 also includes a database 10H. The database 10H can include any data and/or information needed and/or desired for performing any of the processing routines and/or functionality described herein as being performed by the central processing computer(s) 10 and/or by the apparatus 100.

The database 10H can also include any data and/or information needed and/or desired for performing any of the processing routines and/or functionality described herein as being performed by any of the user computers 20, the public election administrator computers 30, the private election administrator computers 40, the campaign administrator computers 50, the provider computers 60, the media computers 70, the external information source computers 80, and/or the financial institution computers 90, described herein.

The database 10H can contain data and/or information regarding the name(s), address or addresses, telephone number(s), facsimile number(s), e-mail address or e-mail addresses, uniform resource locator (url) or urls, contact information, and/or contact name(s), for any of the individuals, entities, business entities, users, candidates, office holders, position holders, campaign managers, campaign administrators, campaign workers, registered voters, eligible voters, central processing computer administrators, public election administrators, public election boards or boards of elections, private election administrators, private election board of boards of election, providers of any goods, products and/or services, which can be utilized and/or employed in a campaign or election, media organizations, press organizations, news organizations, polling organizations, external information sources, and/or financial institutions, and/or any of the respective computers or communication devices associated therewith.

The database 10H can also contain information, including contact information, regarding or for any of the users, individuals, central processing computer operators or administrators, candidates, campaign managers or coordinators, public election administrators or their staff, private election administrators or their staff, campaign administrators, providers, media entities, external information sources, and/or financial institutions, and/or by any other individual, entity, or third party, described herein.

The contact information can include the names, addresses, telephone numbers, fax numbers, e-mail addresses, and/or any other contact information, web sites, and/or any other contact information for any of the users, individuals, central processing computer operators or administrators, candidates, campaign managers or coordinators, public election administrators or their staff, private election administrators or their staff, campaign administrators, providers, media entities, external information sources, and/or financial institutions, and/or by any other individual, entity, or third party, who or which utilize the apparatus 100 of the present invention.

The database 10H can also contain information regarding any of the users, individuals, central processing computer operators or administrators, candidates, campaign managers or coordinators, public election administrators or their staff, private election administrators or their staff, campaign administrators, providers, media entities, external information sources, and/or financial institutions, and/or by any other individual, entity, or third party, described herein.

The database 10H can also contain voter registration data and/or information concerning the names, addresses, party affiliation, voting history, general election voting turnout information, primary election voting turnout information, past nomination petition signing information (i.e. whether an individual has signed nominating petitions and for whom or for what issue or cause. The database 10H can also contain date and/or information concerning preferred voters and/or voters with a high likelihood of voting in an election.

The database 10H can also contain data and/or information regarding each registered voter and/or eligible voter and the election district or political subdivision in which he or she resides, the elective offices or positions which represent and/or which pertain the each voter or voter's residence (i.e. president, governor, congressional representative, senator, elected federal, state and local officials, etc.).

The database 10H can also contain data and/or information regarding each candidate for each elective office representing each registered voter. The database 10H can also contain any data and/or information for allowing any registered voter or other eligible voter to determine which election district or political subdivision he or she lives in as well as the identity and information regarding elective offices representing the voter's election district or political subdivision, candidates for any elective offices pertaining to the voter's election district or political subdivision, and/or information regarding incumbents.

The database 10H can also contain data and/or information concerning eligible voter information, organization membership information, eligible voters in an organization, eligible voters in a union, civic association, public organization, private organization, quasi-public organization, quasi-private organization, school, college, organization, student body, worker group, and/or any other entity or organization which may hold elections or have elective offices in their organization.

The database 10H can also contain any data and/or information regarding any voters and/or electorate, for any types of positions such as, but not limited to, union elections civic association elections, corporate elections, private or public organization elections, student body elections, and/or any other elections or campaigns which can be serviced by the apparatus 100 and methods of the present invention.

The database 10H can also contain data and/or information regarding any individual who can vote in any election, any offices and/or positions which are elective in natures, any issues pertaining to the electorate of any elective office, and/or any other information needed or desired for providing information to a voter, voters, and electorate, and/or any other individual or entity.

The database 10H can also contain information regarding any candidates for any of the elected offices described herein, including resumes, biographic information, credentials, positions on issues, voting records, etc. The database 10H can also contain data and/or information regarding demographics for or regarding any of the voters, voting groups, electorates, and/or geographic regions, described herein.

The database 10H can also contain information regarding voting polling places and/or voting procedures, dates and times for any elections, absentee voting procedures, distance voting procedures, on-line voting procedures, and/or any other information regarding voting and/or voting procedures.

The database 10H can also contain the voting records and/or issue positions for any of the elected officials and/or candidates for elected office(s) and/or political office(s).

The database 10H can also contain data and/or information regarding various issues, campaign issues, election issues, social issues, political issues, etc, for or regarding any governmental territory, subdivision, geographic region, interest group, etc., which may be pertinent and/or related to any elected office, elected position, and/or electorate.

The database 10H can also contain data and/or information regarding various polls or surveys for any issues which may be pertinent to any elected positions described herein and/or otherwise. The database 10H can also contain data and/or information, including, but not limited to, software or algorithms for conducting polling and/or surveys in order to obtain information form a voting electorate and/or other group of individuals and/or entities.

The database 10H can also contain software or algorithms for analyzing polls, surveys, opinion surveys and for conducting surveys and/or polls automatically and/or manually. The database 10H can also contain data and/or information regarding polling information, voter sentiment information, changes in polls, changes in voter sentiment, information for notifying candidates and/or campaigns regarding the existence of, and/or occurrence, of any polls and/or surveys.

The database 10H can also contain data and/or information regarding campaign literature and/or for designing, producing, generating, and/or disseminating, campaign literature and/or campaigning literature. The database 10H can also contain data and/or information regarding literature mailing lists, e-mailing lists, etc. The database 10H can also contain data and/or information for disseminating campaign information to respective voters and/or a voting electorate, and/or for disseminating campaign information to targeted voters and/or targeted segments of an electorate or voter groups.

The database 10H can also contain data and/or information regarding campaign and/or election laws, rules, and/or regulations, for or regarding any public and/or private elections and/or election campaigns. The database 10H can also contain data and/or information for generating campaign nominating petitions, campaign disclosure forms, financial disclosure forms, information dissemination forms, press release forms, and/or campaign related forms of any kind for any of the campaigns, public or private, described herein and/or otherwise.

The database 10H can also contain data and/or information regarding fundraising efforts, fundraising invitation information, fundraising planning information, fundraising efforts, fundraising issues, fundraising accounting, information for contacting individuals for fundraising donations, information for performing fundraising efforts, information for performing targeted and/or focused fundraising efforts, and/or any other information for and/or regarding, fundraising by any candidates and/or organizations who or which may utilize the present invention.

The database 10H can also contain data and/or information regarding schedules, scheduling information, and/or any other calendar information, which can or may be pertinent to an election campaign. The database 10H can also contain data and/or information regarding the scheduling of any and/or all political events, official events, public events, private events, civic events, charitable events, ethnic events, and/or any other events or scheduled events or occurrences which may be of interest to any users, candidates, campaigns, and/or organizations, who or which may utilize the present invention. The database 10H can also contain data and/or information for providing notification to any interested individual, candidate, campaign, and/or organization, of any events and/or any information related thereto.

The database 10H can also contain campaign advertisements, campaign literature, commercials, video commercials and/or video clips, audio commercials and/or audio clips, and/or audio and video commercials and/or segments for promoting a candidate, a slate of candidates, and/or an issue, a cause, a program, and/or any other campaign.

The database 10H can also contain data and/or information regarding reviews and/or comments regarding events, including, but not limited to, the value of attending the event, the exposure one may receive form an event, and/or any other information regarding any other events described herein.

The database can also contain any data, information, software programs, and/or algorithm, for automatically and/or electronically carrying out a campaigns of any kind including information and/or literature dissemination, mailing, electronic mailing, polling, fundraising, financial disclosure reporting, electioneering, and/or any other campaigning and/or campaign management functions and/or tasks.

The database 10H can also contain data and/or information for or regarding news, news updates, issues, campaign issues, and/or any other information which can or may be pertinent to a campaign.

The database 10H can also contain data and/or information for or regarding past elections, past campaigns, voter turnout, voter responsiveness to certain campaign efforts, campaigning activities, the use and/or effectiveness of campaign tactics, campaign strategy or strategies, campaign products, goods, services, and/or consultants.

The database 10H can also contain statistical data and/or information for or regarding past elections, past campaigns, voter turnout, voter responsiveness to certain campaign efforts, campaigning activities, the use and/or effectiveness of campaign tactics, campaign strategy or strategies, campaign products, goods, services, and/or consultants.

The database can also contain data and/or information for or regarding any of the various goods providers, campaign goods providers, products providers, campaign products providers, services providers, campaign services providers, campaign consultants, campaign workers, campaign managers, including, but not limited to, the their respective names, addresses, telephone and/or facsimile numbers, e-mail addresses, the respective goods, products, and/or services, they provide and/or perform, the prices and/or charges for the respective goods, products, and/or services, reviews by past customers or clients, effectiveness of the respective goods, products, and/or services, and/or any other information which may be pertinent to any of the providers and/or to any of the respective goods, products and/or services which they provide.

The database can also contain data and/or information regarding lobbyists for any interests as well as the interests they represent. The database 10H can also contain data and/or information for or regarding any associations, civic groups, special interest groups, political action committees, unions, trade associations, and/or any other individuals, organizations, and/or entities, who or which may take an interest in, be a factor in, and/or issue endorsements for candidates in, any election or campaign. The information can also include membership information, demographic information, past endorsement information, past campaign contributions, endorsement effectiveness, and/or any other information regarding any of the herein-described associations, civic groups, special interest groups, unions, trade associations, political action committees, and/or any other individuals, organizations, and/or entities.

The information stored in the database 10H can also include the name, address, telephone and facsimile numbers, e-mail address and individual contact(s) and/or contact information for any of the herein-described associations, civic groups, special interest groups, unions, trade associations, political action committees, and/or any other individuals, organizations, and/or entities.

The database 10H can also contain data and/or information regarding press releases regarding candidates, elective offices, campaigns, and/or other related information. The database 10H can also contain data and/or information regarding when candidates, political parties, associations, civic groups, special interest groups, unions, trade associations, political action committees, and/or any other individuals, organizations, and/or entities, file documents and/or filings of any kind, such as, but not limited to nomination petitions, nomination documents, financial disclosure forms, financial disclosure filing forms, any/or any other official and/or unofficial filings along with any information contained in any of these filings.

The database 10H can also contain data and/or information regarding current office holders, challengers, and/or candidates. The database 10H can also contain data and/or information regarding campaigns, elections, campaign management, election laws, elections regulations, election rules, and/or any other information, for any public and private elections for which the apparatus 100 can be utilized.

The database 10H can also contain data and/or information regarding the financial accounts or campaign accounts for any of the candidates or organizations who or which utilize the present invention. The database 10H can also contain information for preparing and filing financial disclosure forms of documents for, or on behalf of, any of the candidates, political parties, political action committees, lobbyist groups, and/or any other individual and/or organization, who or which utilizes the present invention.

The database 10H can also contain data, information, software programs, and/or software algorithms, for generating and producing electronic catalogs contain candidate and/or campaign information, for bidding for, and/or for auctioning off, certain campaign and/or campaign-related goods, products, and/or services, for performing recruitment for campaign managers, campaign staff workers, consultants and advisors, and/or any other service provider, and/or for providing incentive-based campaign advertisements and/or polling.

In addition, the database 10H, as well as any of the respective databases associated with any of the via the central processing computer and/or via any of the user computers 20, the public election administrator computers 30, the private election administrator computers 40, the campaign administrator computers 50, the provider computers 60, the media computers 70, the external information source computers 80, and/or the financial institution computers 90, described herein, can contain any other data and/or information needed and/or desired for performing any and/or all of the processing routines and/or functions described herein as being performed and/or provider by the apparatus 100 and method of the present invention.

Any of the data and/or information described as being stored in the database 10H, and/or any of the other respective databases of the via the central processing computer and/or via any of the user computers 20, the public election administrator computers 30, the private election administrator computers 40, the campaign administrator computers 50, the provider computers 60, the media computers 70, the external information source computers 80, and/or the financial institution computers 90, can be entered, updated, and/or changed via the central processing computer and/or via any of the user computers 20, the public election administrator computers 30, the private election administrator computers 40, the campaign administrator computers 50, the provider computers 60, the media computers 70, the external information source computers 80, and/or the financial institution computers 90, described herein.

In this regard, for example, any individual or entity, can via a respective computer, enter information and/or data into the database 10H and/or any of the databases of any of the respective user computers 20, the public election administrator computers 30, the private election administrator computers 40, the campaign administrator computers 50, the provider computers 60, the media computers 70, the external information source computers 80, and/or the financial institution computers 90, described herein.

Any of the data and/or information described herein can be provided from multiple information sources and/or from multiple individuals or entities by utilizing any of the respective central processing computers 10, the user computers 20, the public election administrator computers 30, the private election administrator computers 40, the campaign administrator computers 50, the provider computers 60, the media computers 70, the external information source computers 80, and/or the financial institution computers 90.

The database 10H can also contain any other information which may be relevant, pertinent, useful, and/or desired, for facilitating the operation of the apparatus and method of the present invention as described herein and/or as related thereto.

The database 10H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6th Edition, Prentice Hall 1996.

The database 10H, or collection of databases, may be updated by each of the respective users, individuals, central processing computer operators or administrators, candidates, campaign managers or coordinators, public election administrators or their staff, private election administrators or their staff, campaign administrators, providers, media entities, external information sources, and/or financial institutions, and/or by any other individual, entity, or third party, in real-time and/or otherwise, and/or via dynamically linked database management techniques.

The data and/or information stored in the database 10H can also be updated by external sources. The database 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2nd Ed., Addison-Wesley Publishing Company, 1994.

The database 10H can also include any other data and/or information needed and/or desired for facilitating the functions and operation of the present invention as described herein.

With reference once again to FIG. 2, the central processing computer 10 also includes an output device 10I such as a printer, a modem, a fax/modem, or other output device, for providing data and/or information to the operator or user of the central processing computer 10 or to a third party or third party entity.

In the preferred embodiment, each of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention, can include the same, similar, or analogous, components and/or peripheral devices as described herein for the central processing computer 10. In this manner, any user computer 20, public election administrator computer 30, private election administrator computer 40, campaign administrator computer 50, provider computer 60, media computer 70, external information source computer 80, and/or financial institution computer 90 which may be utilized in conjunction with the present invention, may be the same as, or be similar to, the central processing computer 10.

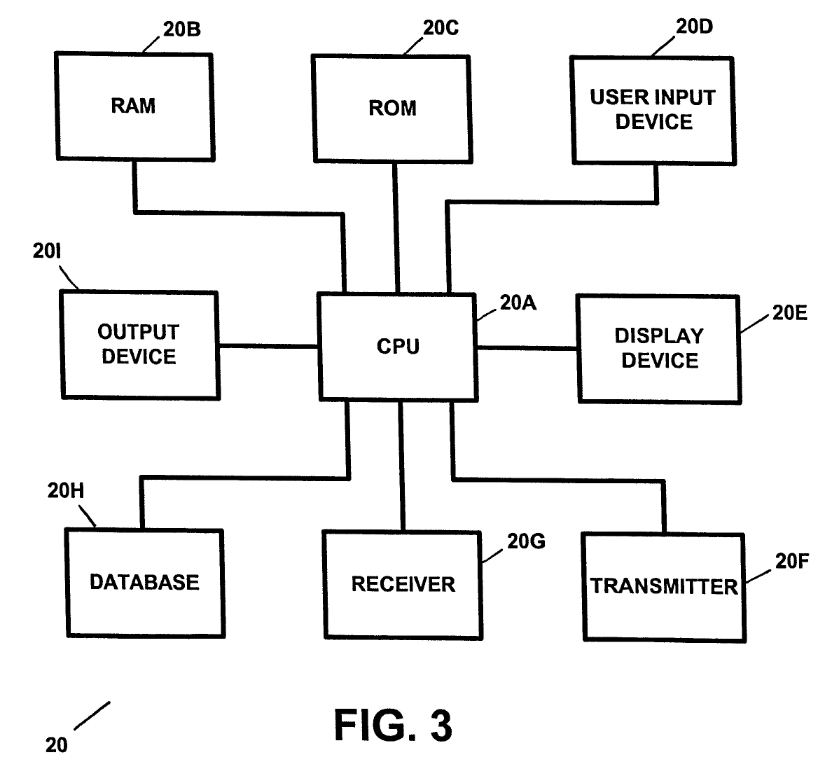

FIG. 3 illustrates the user computer 20, in block diagram form. In the preferred embodiment, the user computer 20 includes a central processing unit or CPU 20A, which in the preferred embodiment, is a microprocessor. The CPU 20A can also be a microcomputer, a minicomputer, a macro-computer, and/or a mainframe computer, depending upon the application.

The user computer 20 also includes a random access memory device(s) 20B (RAM) and a read only memory device(s) 20C (ROM), each of which is connected to the CPU 20A, a user input device 20D, for entering data and/or commands into the user computer 20, which includes any one or more of a keyboard, a scanner, a user pointing device, such as, for example, a mouse, a touch pad, and/or an audio input device and/or a video input device, etc., if desired, which input device(s) is also connected to the CPU 20A. The user computer 20 also includes a display device 20E for displaying data and/or information to a user or operator.

The user computer 20 also includes a transmitter(s) 20F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The user computer 20 also includes a receiver 20G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The user computer 20 also includes a database(s) 20H which can contain any and/or all of the data and/or information described herein with regards to the database 10H of the central processing computer 10 and/or any of the other information regarding or of interest to the user. The database 20H can also contain any other data and/or information which is or which may be needed in performing any of the respective processing routines described herein.

With reference once again to FIG. 3, the user computer 20 also includes an output device 20I such as a printer, a modem, a fax/modem, or other output device, for providing data and/or information to the operator or user of the user computer 20 or to a third party or third party entity.

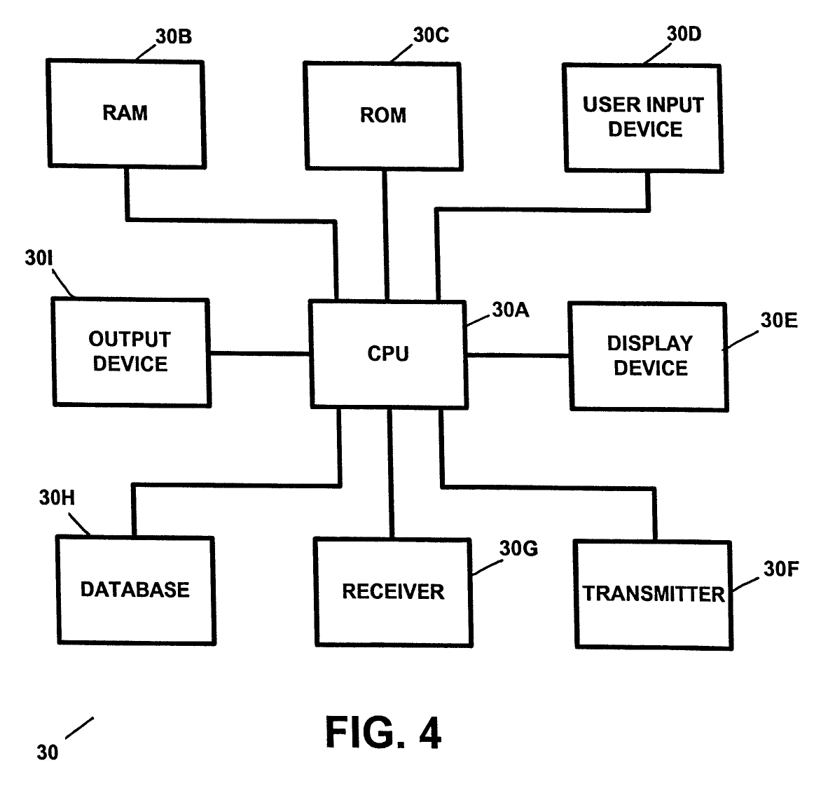

FIG. 4 illustrates the public election administrator computer 30, in block diagram form. In the preferred embodiment, the public election administrator computer 30 includes a central processing unit or CPU 30A, which in the preferred embodiment, is a microprocessor. The CPU 30A can also be a microcomputer, a minicomputer, a macro-computer, and/or a mainframe computer, depending upon the application.

The public election administrator computer 30 also includes a random access memory device(s) 30B (RAM) and a read only memory device(s) 30C (ROM), each of which is connected to the CPU 30A, a user input device 30D, for entering data and/or commands into the public election administrator computer 30, which includes any one or more of a keyboard, a scanner, a user pointing device, such as, for example, a mouse, a touch pad, and/or an audio input device and/or a video input device, etc., if desired, which input device(s) is also connected to the CPU 30A. The public election administrator computer 30 also includes a display device 30E for displaying data and/or information to a user or operator.

The public election administrator computer 30 also includes a transmitter(s) 30F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The public election administrator computer 30 also includes a receiver 30G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The public election administrator computer 30 also includes a database(s) 30H which can contain any and/or all of the data and/or information described herein with regards to the database 10H of the central processing computer 10 and/or any of the other information regarding or of interest to the user. The database 30H can also contain any other data and/or information which is or which may be needed in performing any of the respective processing routines described herein.

With reference once again to FIG. 4, the public election administrator computer 30 also includes an output device 30I such as a printer, a modem, a fax/modem, or other output device, for providing data and/or information to the operator or user of the public election administrator computer 30 or to a third party or third party entity.

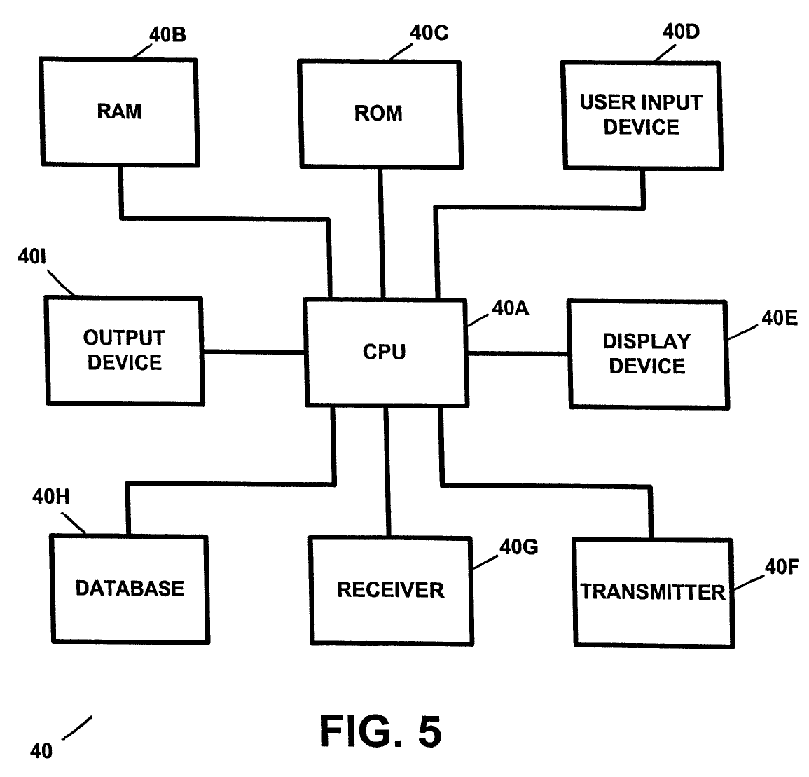

FIG. 5 illustrates the private election administrator computer 40, in block diagram form. In the preferred embodiment, private election administrator computer 40 includes a central processing unit or CPU 40A, which in the preferred embodiment, is a microprocessor. The CPU 40A can also be a microcomputer, a minicomputer, a macro-computer, and/or a mainframe computer, depending upon the application.

The private election administrator computer 40 also includes a random access memory device(s) 40B (RAM) and a read only memory device(s) 40C (ROM), each of which is connected to the CPU 40A, a user input device 40D, for entering data and/or commands into the private election administrator computer 40, which includes any one or more of a keyboard, a scanner, a user pointing device, such as, for example, a mouse, a touch pad, and/or an audio input device and/or a video input device, etc., if desired, which input device(s) is also connected to the CPU 40A. The private election administrator computer 40 also includes a display device 40E for displaying data and/or information to a user or operator.

The private election administrator computer 40 also includes a transmitter(s) 40F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The private election administrator computer 40 also includes a receiver 40G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The private election administrator computer 40 also includes a databases) 40H which can contain any and/or all of the data and/or information described herein with regards to the database 10H of the central processing computer 10 and/or any of the other information regarding or of interest to the user. The database 40H can also contain any other data and/or information which is or which may be needed in performing any of the respective processing routines described herein.

With reference once again to FIG. 5, the private election administrator computer 40 also includes an output device 40I such as a printer, a modem, a fax/modem, or other output device, for providing data and/or information to the operator or user of the private election administrator computer 40 or to a third party or third party entity.

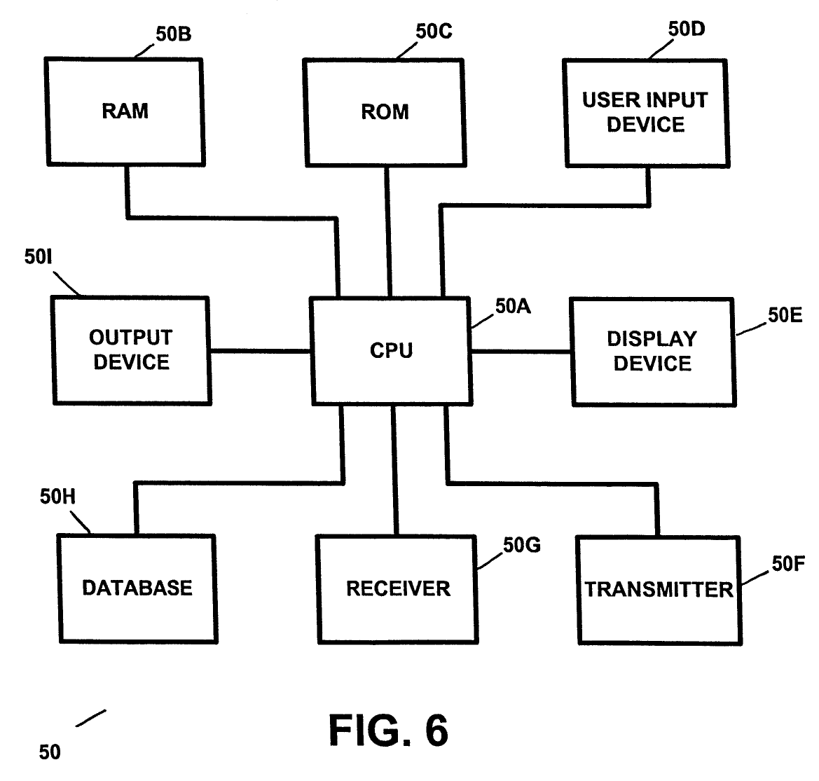

FIG. 6 illustrates the campaign administrator computer 50, in block diagram form. In the preferred embodiment, the campaign administrator computer 50 includes a central processing unit or CPU 50A, which in the preferred embodiment, is a microprocessor. The CPU 50A can also be a microcomputer, a minicomputer, a macro-computer, and/or a mainframe computer, depending upon the application.

The campaign administrator computer 50 also includes a random access memory device(s) 50B (RAM) and a read only memory device(s) 50C (ROM), each of which is connected to the CPU 50A, a user input device 50D, for entering data and/or commands into the campaign administrator computer 50, which includes any one or more of a keyboard, a scanner, a user pointing device, such as, for example, a mouse, a touch pad, and/or an audio input device and/or a video input device, etc., if desired, which input device(s) is also connected to the CPU 50A. The campaign administrator computer 50 also includes a display device 50E for displaying data and/or information to a user or operator.

The campaign administrator computer 50 also includes a transmitter(s) 50F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The campaign administrator computer 50 also includes a receiver 50G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The campaign administrator computer 50 also includes a database(s) 50H which can contain any and/or all of the data and/or information described herein with regards to the database 10H of the central processing computer 10 and/or any of the other information regarding or of interest to the user. The database 50H can also contain any other data and/or information which is or which may be needed in performing any of the respective processing routines described herein.

With reference once again to FIG. 6, the campaign administrator computer 50 also includes an output device 50I such as a printer, a modem, a fax/modem, or other output device, for providing data and/or information to the operator or user of the campaign administrator computer 50 or to a third party or third party entity.

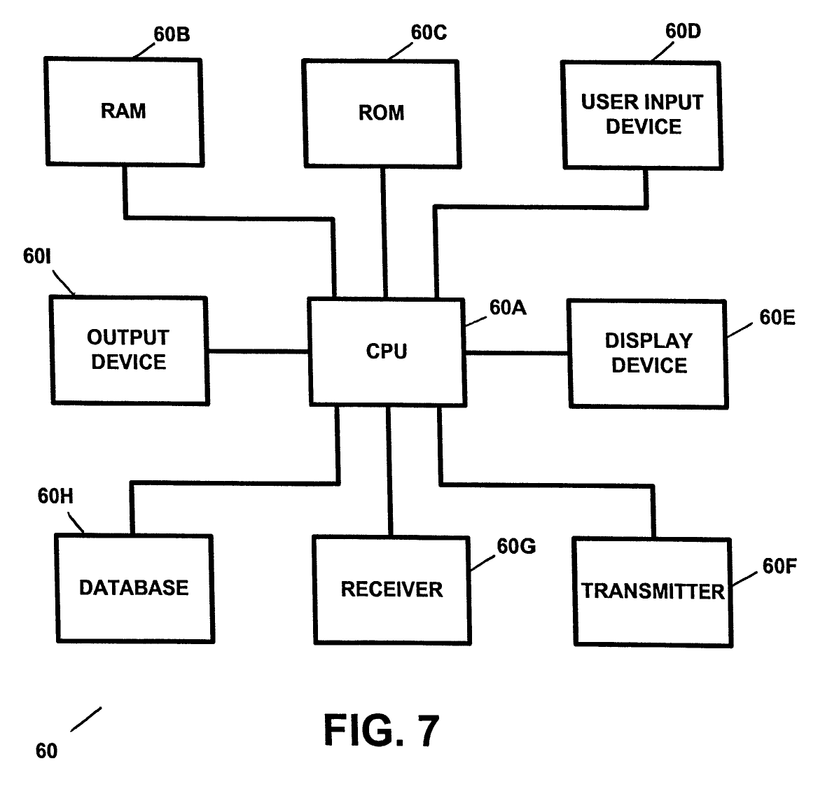

FIG. 7 illustrates the provider computer 60, in block diagram form. In the preferred embodiment, provider computer 60 includes a central processing unit or CPU 60A, which in the preferred embodiment, is a microprocessor. The CPU 60A can also be a microcomputer, a minicomputer, a macro-computer, and/or a mainframe computer, depending upon the application.

The provider computer 60 also includes a random access memory device(s) 60B (RAM) and a read only memory device(s) 60C (ROM), each of which is connected to the CPU 60A, a user input device 60D, for entering data and/or commands into the provider computer 60, which includes any one or more of a keyboard, a scanner, a user pointing device, such as, for example, a mouse, a touch pad, and/or an audio input device and/or a video input device, etc., if desired, which input device(s) is also connected to the CPU 60A. The provider computer 60 also includes a display device 60E for displaying data and/or information to a user or operator.

The provider computer 60 also includes a transmitter(s) 60F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The provider computer 60 also includes a receiver 60G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The provider computer 60 also includes a database(s) 60H which can contain any and/or all of the data and/or information described herein with regards to the database 10H of the central processing computer 10 and/or any of the other information regarding or of interest to the user. The database 60H can also contain any other data and/or information which is or which may be needed in performing any of the respective processing routines described herein.

With reference once again to FIG. 7, the provider computer 60 also includes an output device 60I such as a printer, a modem, a fax/modem, or other output device, for providing data and/or information to the operator or user of the provider computer 60 or to a third party or third party entity.

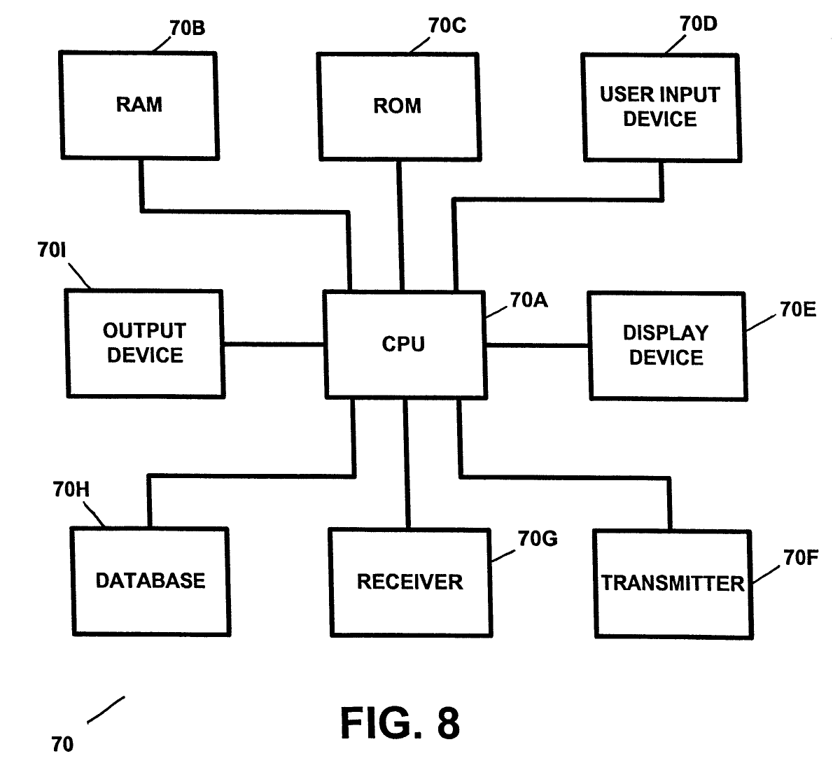

FIG. 8 illustrates the media computer 70, in block diagram form. In the preferred embodiment, the media computer 70 includes a central processing unit or CPU 70A, which in the preferred embodiment, is a microprocessor. The CPU 70A can also be a microcomputer, a minicomputer, a macro-computer, and/or a mainframe computer, depending upon the application.

The media computer 70 also includes a random access memory device(s) 70B (RAM) and a read only memory device(s) 70C (ROM), each of which is connected to the CPU 70A, a user input device 70D, for entering data and/or commands into the media computer 70, which includes any one or more of a keyboard, a scanner, a user pointing device, such as, for example, a mouse, a touch pad, and/or an audio input device and/or a video input device, etc., if desired, which input device(s) is also connected to the CPU 70A. The media computer 70 also includes a display device 70E for displaying data and/or information to a user or operator.

The media computer 70 also includes a transmitter(s) 70F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The media computer 70 also includes a receiver 70G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The media computer 70 also includes a database(s) 70H which can contain any and/or all of the data and/or information described herein with regards to the database 10H of the central processing computer 10 and/or any of the other information regarding or of interest to the user. The database 70H can also contain any other data and/or information which is or which may be needed in performing any of the respective processing routines described herein.

With reference once again to FIG. 8, the media computer 70 also includes an output device 70I such as a printer, a modem, a fax/modem, or other output device, for providing data and/or information to the operator or user of the media computer 70 or to a third party or third party entity.

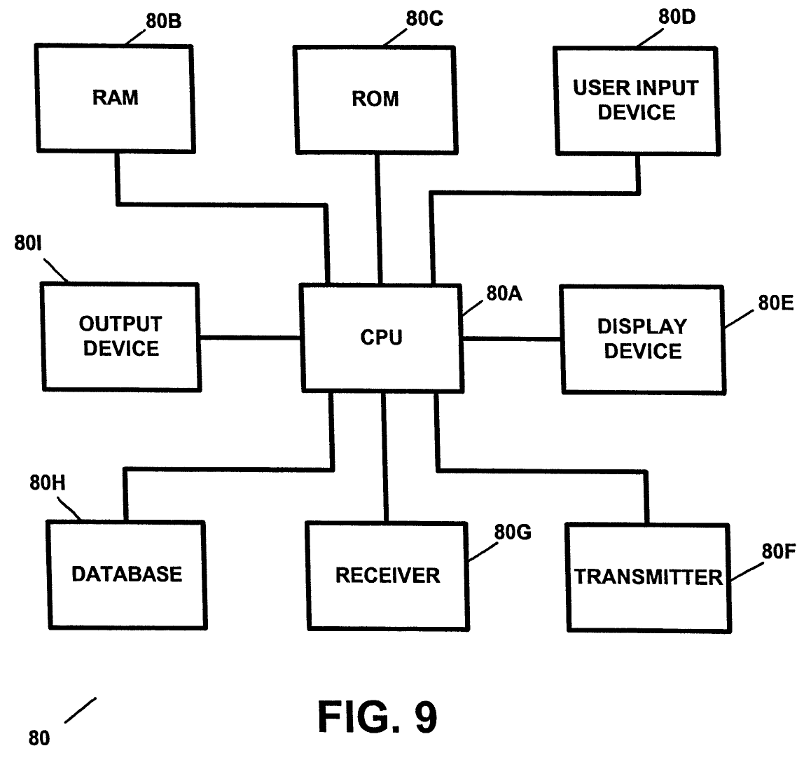

FIG. 9 illustrates the external information source computer 80, in block diagram form. In the preferred embodiment, the external information source computer 80 includes a central processing unit or CPU 80A, which in the preferred embodiment, is a microprocessor. The CPU 80A can also be a microcomputer, a minicomputer, a macro-computer, and/or a mainframe computer, depending upon the application.

The external information source computer 80 also includes a random access memory device(s) 80B (RAM) and a read only memory device(s) 80C (ROM), each of which is connected to the CPU 80A, a user input device 80D, for entering data and/or commands into the user computer 80, which includes any one or more of a keyboard, a scanner, a user pointing device, such as, for example, a mouse, a touch pad, and/or an audio input device and/or a video input device, etc., if desired, which input device(s) is also connected to the CPU 80A. The external information source computer 80 also includes a display device 80E for displaying data and/or information to a user or operator.

The external information source computer 80 also includes a transmitter(s) 80F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The external information source computer 80 also includes a receiver 80G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The external information source computer 80 also includes a database(s) 80H which can contain any and/or all of the data and/or information described herein with regards to the database 10H of the central processing computer 10 and/or any of the other information regarding or of interest to the user. The database 80H can also contain any other data and/or information which is or which may be needed in performing any of the respective processing routines described herein.

With reference once again to FIG. 9, the external information source computer 80 also includes an output device 80I such as a printer, a modem, a fax/modem, or other output device, for providing data and/or information to the operator or user of the external information source computer 80 or to a third party or third party entity.

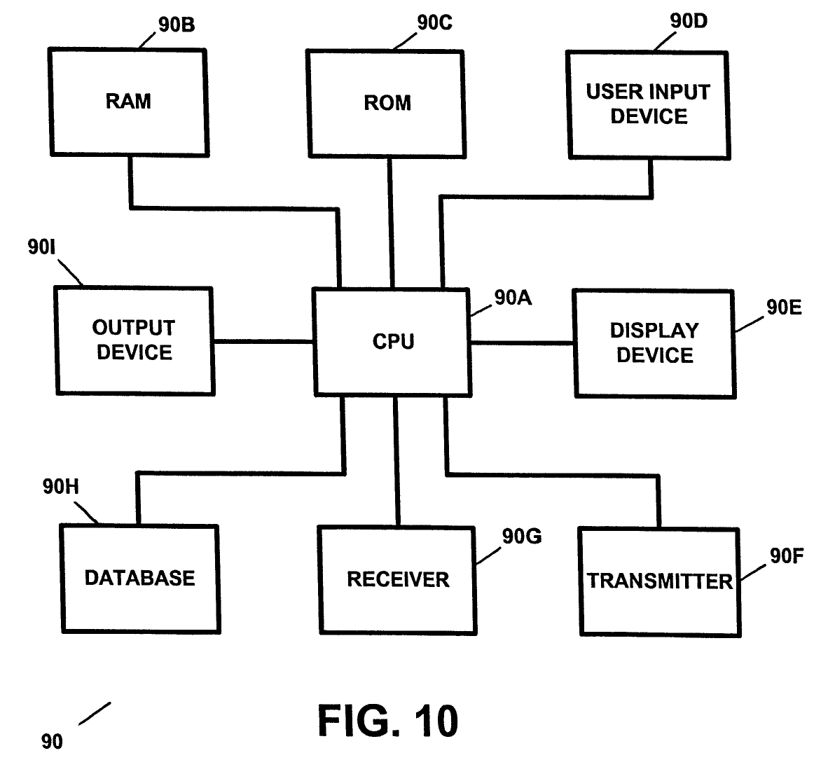

FIG. 10 illustrates the financial institution computer 90, in block diagram form. In the preferred embodiment, the financial institution computer 90 includes a central processing unit or CPU 90A, which in the preferred embodiment, is a microprocessor. The CPU 90A can also be a microcomputer, a minicomputer, a macro-computer, and/or a mainframe computer, depending upon the application.

The financial institution computer 90 also includes a random access memory device(s) 90B (RAM) and a read only memory device(s) 90C (ROM), each of which is connected to the CPU 90A, a user input device 90D, for entering data and/or commands into the financial institution computer 90, which includes any one or more of a keyboard, a scanner, a user pointing device, such as, for example, a mouse, a touch pad, and/or an audio input device and/or a video input device, etc., if desired, which input device(s) is also connected to the CPU 90A. The financial institution computer 90 also includes a display device 90E for displaying data and/or information to a user or operator.

The financial institution computer 90 also includes a transmitter(s) 90F, for transmitting signals and/or data and/or information to any one or more of the central processing computers 10, the user computers 20, the public election administrator computers 30, the private election administrator computers 40, the campaign administrator computers 50, the provider computers 60, the media computers 70, the external information source computers 80, and/or the financial institution computer 90, which may be utilized in conjunction with the present invention.

The financial institution computer 90 also includes a receiver 90G, for receiving signals and/or data and/or information from any one or more of the central processing computer(s) 10, the user computers 20, the public election administrator computers 30, the private election administrator computers 40, the campaign administrator computers 50, the provider computers 60, the media computers 70, the external information source computers 80, and/or the financial institution computers 90, which may be utilized in conjunction with the present invention.

The financial institution computer 90 also includes a databases) 90H which can contain any and/or all of the data and/or information described herein with regards to the database 10H of the central processing computer 10 and/or any of the other information regarding or of interest to the user. The database 290H can also contain any other data and/or information which is or which may be needed in performing any of the respective processing routines described herein.

With reference once again to FIG. 10, the financial institution computer 90 also includes an output device 90I such as a printer, a modem, a fax/modem, or other output device, for providing data and/or information to the operator or user of the financial institution computer 90 or to a third party or third party entity.

The databases 20H, 30H, 40H, 50H, 60H, 70H, 80H, and/or 90H, can contain any and/or all of the data and/or information which is stored and/or contained in the database 10H. In the same manner, any of the data and/or information which is stored in the databases 20H, 30H, 40H, 50H, 60H, 70H, 80H, and/or 90H, can be stored in the database 10H.

The database 10H, or collection of databases which form the database 10H, as well as any database 20H, 30H, 40H, 50H, 60H, 70H, 80H, and/or 90H, described herein, can be implemented by utilizing database software and/or spreadsheet software, such as, for example database software by Oracle®, Microsoft® Access® and/or Microsoft® Excel®, or any other suitable database or spreadsheet software programs and/or systems.

The data and/or information which is stored in the database 20H, 30H, 40H, 50H, 6OH, 70H, 80H, and/or 90H, can be linked via any suitable data linking techniques such as, for example, dynamically linked lists (DLLs), linked lists, and object links embedded (OLE's).

The data and/or information which is stored in the database 10H can be entered and/or updates manually by an operator, automatically by a communication link from the respective information sources, and/or via links, communication links, and/or dynamically linked lists, to, and/or with, any of the other databases 20H, 30H, 40H, 50H, 60H, 70H, 80H, and/or 90H, and/or any other individual or entity. Any of the data and/or information stored in any of the databases 20H, 30H, 40H, 50H, 60H, 70H, 80H, and/or 90H, utilized in the present invention, can be updated at specified time intervals, at certain times, times of day, days, days of week, daily, weekly, bi-weekly, monthly, quarterly, semi-annually, annually, and/or at any of the time interval or period, upon the occurrence of certain events, and/or upon the occurrence of any pre-specified event or activity.

Any of the databases 10H, 20H, 30H, 40H, 5OH, 60H, 70H, 80H, and/or 90H, described herein, can include multiple databases, databases on different computers, and/or databases on computers which are external from their respective resident computers.

Any of the computers 10, 20, 30, 40, 50, 60, 70, 80, and/or 90, described herein, can include a multiple computers and/or computer systems.

Any of the databases 10H, 20H, 30H, 40H, 50H, 60H, 70H, 80H, and/or 90H, described herein, in the preferred embodiment, will contain statistical data and/or information concerning any of the data and/or information stored in said databases. The statistical data and/or information can be utilized to perform historical analyses, present analyses, future predictions, and/or forecasting, as well as providing any data and/or information which can be utilized by the present invention in performing any of the operations described herein.

The database 10H may contain any number of database, relational databases, and/or other databases. The database 10H, as well as any of the other databases 20H, 30H, 40H, 50H, 60H, 70H, 80H, and/or 90H, can also include and/or contain spreadsheets for storing any data and/or information described herein as well as for performing various calculations needed for utilizing the apparatus 100, any of the computers 20, 30, 40, 50, 60, 70, 80, and/or 90, and/or any of the components thereof.

The present invention can be utilized in a number of preferred embodiments in order to perform a wide variety of processing routines. In a preferred embodiment, the apparatus 100 and method of the present invention can be utilized in order to provide campaign and/or campaigning information to any user of the present invention. In another preferred embodiment, the apparatus and method of the present invention can be utilized in order to provide campaign management information and/or information for assisting in managing a campaign.

In another preferred embodiment, the apparatus and method of the present invention can be utilized in order to generate, produce, and/or disseminate, campaign materials, campaign literature, and/or press releases. In another embodiment, the apparatus and method of the present invention can be utilized in order to perform polling and/or surveys and/or to make the results of the respective polls and/or surveys to any respective users of the present invention.

In still another preferred embodiment, the apparatus and method of the present invention can be utilized to perform targeted information dissemination such as campaign mailings as well as fundraising and targeted fundraising activities. In yet another preferred embodiment, the apparatus and method of the present invention can be utilized as a clearinghouse for buying and selling campaign goods, campaign products, campaign services, campaign-related goods, campaign-related products, and/or campaign-related services.

In another preferred embodiment, the apparatus and method of the present invention can be utilized in order to provide notification to a provider of campaign goods, campaign products and/or campaign services, and/or any other campaign-related goods, products, and/or services, of the existence of an individual, candidate, and/or any other of the herein-described organizations, who or which may be in need of, and/or who or which may be interested in, the respective goods, products, and/or services, which are offered by the respective providers.

In still another preferred embodiment, the apparatus and method of the present invention can be utilized in order to provide notification to an individual, a candidate, and/or any of the herein-described organizations, of the existence of a provider of campaign goods, campaign products and/or campaign services, and/or any other campaign-related goods, products, and/or services.

In yet another preferred embodiment, the apparatus and method of the present invention can be utilized in order to perform fundraising activities and/or for performing financial accounting services for or regarding a campaign. In another preferred embodiment, the apparatus and method of the present invention can be utilized in order to provide notification and/or reminders to a candidate, a campaign manager and/or campaign staff, and/or any of the herein-described organizations, of required actions and/or filings which must be taken during a campaign. In still another preferred embodiment, the apparatus and method of the present invention can be utilized in order to maintain event schedules and/or calendars and/or to provide notification of event to any of the users, individuals, candidates, campaigns, and/or any of the organizations, described herein.

In yet another preferred embodiment, the apparatus and method of the present invention can be utilized in order to provide notification of news, polls, polling results, surveys, and/or survey results, to any of the users, individuals, candidates, campaigns, and/or any of the organizations, described herein.

In another preferred embodiment, the apparatus and method of the present invention can be utilized in order to administer and/or manage financial accounts, and/or to transmit and/or receive payments and/or funds transfer, for, or on behalf of, any of the candidates, campaigns, providers, organizations, and/or any other users, of the present invention.

In another preferred embodiment, the apparatus and method of the present invention can be utilized to conducts a poll, polls, a survey, or surveys, for any of the users, individuals, candidates, campaigns, political parties, and/or organizations. The apparatus and method of the present invention can be programmed to analyze the results of the respective poll, polls, a survey, or surveys, identify areas of weakness or vulnerability, and disseminate campaign materials to targeted voters or areas in order to attempt to overcome the weakness or vulnerability.

In any and/or all of the embodiments described herein, the apparatus 100 and method of the present invention can be utilized in conjunction with, and/or process information for and/or provide information for or regarding any kind of campaign and/or any kind of election.

The apparatus and method of the present invention, in any of the embodiments described herein, can be utilized in conjunction with a campaigns) or elections) for public offices, private offices, private organization elections, corporate elections of any kind, union elections, school elections, student body elections, trade association elections, civic association elections, and/or any other public elections, private elections, quasi-public elections, and/or quasi-private elections, of any kind or type.

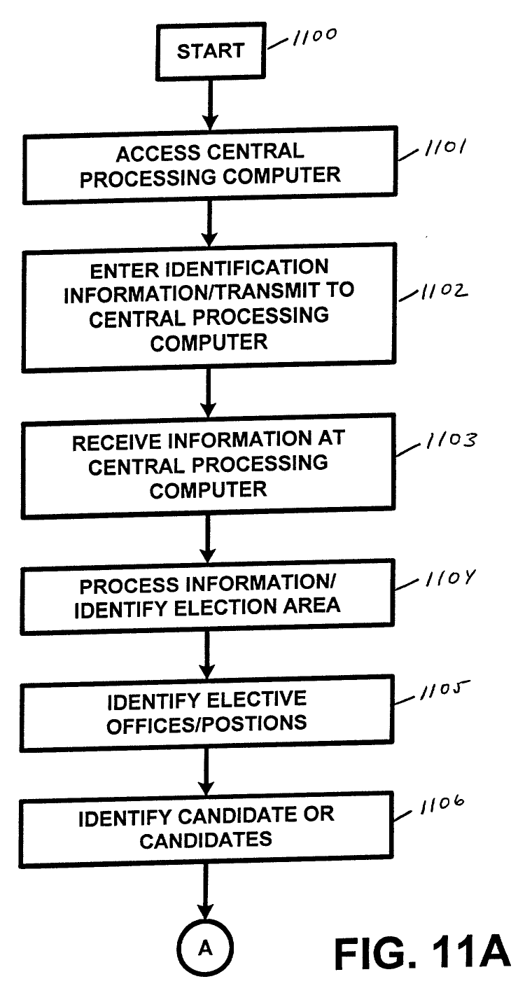

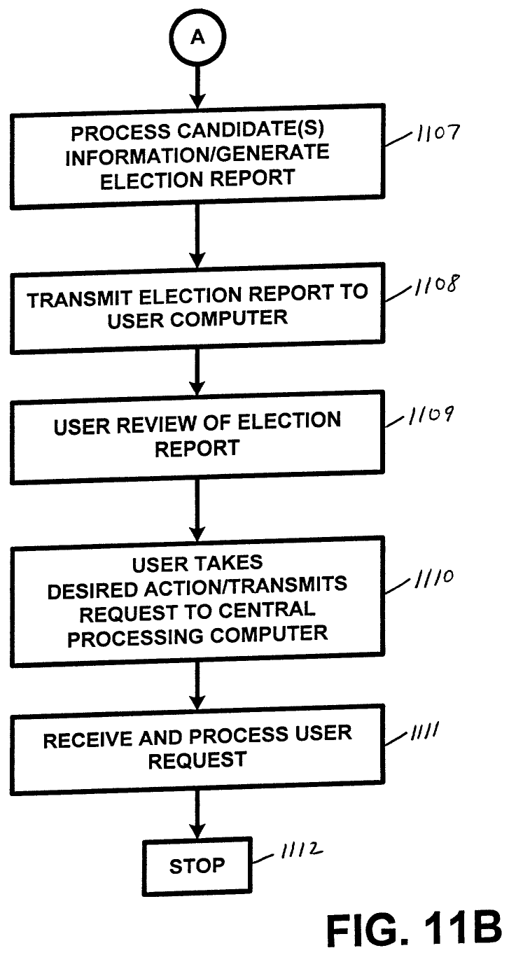

In a preferred embodiment, the apparatus 100 and method of the present invention can be utilized in order to provide campaign and/or campaigning information to any user of the present invention. FIGS. 11A and 11B illustrate a preferred embodiment method for utilizing the present invention, in flow diagram form.

The embodiment of FIGS. 11A and 11B can be utilized for providing information for any type of election and/or campaign, including elections for public office or public offices and/or elections for offices and/or positions in private organizations, quasi-public organizations, and/or quasi-private organizations. As an example, the embodiment of FIGS. 11A and 11B will be herein-described as being utilized in order to provide information to users, individuals, voters, and/or constituents (hereinafter referred to as “user” or “users”), regarding elections and/or campaigns for public office or public offices.

In the embodiment of FIGS. 11A and 11B, it is envisioned that a user, a candidate, a campaign manager, a campaign staff, a political party, and/or any other individual(s) and/or entity, will register and/or post any relevant information with the apparatus 100 and/or the central processing computer 10.

With reference to FIGS. 11A and 11B, the operation of the apparatus 100 commences at step 1100. At step 1101, the user accesses the central processing computer 10 via the respective user computer 20. At step 1102, the user an enter identification information, which can be his or her name, voter registration number, and/or address or residence, and transmit same to the central processing computer 10.

At step 1103, the central processing computer 10 will receive the user information. At step 1104, the central processing computer 10 will process the user information and identify the user's election district or election area. At step 1105, the central processing computer 10 will identify and/or ascertain the offices or positions for which elections are to be held. For example, a certain election district or municipality may be voting in the next or upcoming election in order to elect a congressman or congresswomen, a mayor, a town council representative, and a judge. The present invention can also process any of the herein-described information for any election, general election, primary election, and/or special election.

At step 1106, the central processing computer 10 will identify all of the candidates for all of the offices or positions which are identified at step 1105. At step 1107, the central processing computer 10 will process the information regarding the candidates identified at step 1106.

The central processing computer 10 will process, collect and/or aggregate, any and/or all candidate information which can be stored in the database 10H and which can include, but which is not limited to, candidate name, profile, resume, credentials, platform, position on issues, campaign literature, campaign advertisements, campaign commercials, campaign polls, campaign surveys, campaign fundraiser or fundraising information, and/or any other candidate and/or campaign related information regarding and/or related to the candidate.

At any time, any candidates), campaigns), campaign staff(s), political party or parties, group(s) or slate(s) of candidates, public elections administrators), private elections administrators, group(s), association(s), organization(s), and/or any other individual or entity, can access the central processing computer 10 and post information concerning any of the elections, offices, positions, candidates, campaigns, and/or any and/or all candidate information which can include, but which is not limited to, candidate name, profile, resume, credentials, platform, position on issues, campaign literature, campaign advertisements, campaign commercials, campaign polls, campaign surveys, campaign fundraiser or fundraising information, and/or any other candidate and/or campaign related information regarding and/or related to the candidate. Any of the herein-described information can be processed by the central processing computer 10, can be stored in the database 10H, and can be made available for any processing and/or generation of any of the election reports and/or information described herein.

The election report can also contain information describing each office or position, its duties and responsibilities, and/or the voting records or platforms of the candidates regarding issues associated with and/or corresponding to the office or position.

At step 1107, the central processing computer will also generate an election report which will contain any of the herein-described information, and/or links or hyperlinks to any of the herein-described and/or related information, for each of the candidates for office in the upcoming election. At step 1108, the central processing computer 10 will transmit the election report to the user computer 20 associated with the user. At step 1109, the user can review the information contained in the election report for any of the campaigns and/or candidates described herein.

In another preferred embodiment, the user can, at step 1109, receive compensation and/or can be paid for viewing an advertisement and/or commercial for, and/or for participating in a survey or poll by, a candidate or group of candidates. Applicant hereby incorporates by reference herein the subject matter and teachings of U.S. Provisional Patent Application Serial No. 60/213,331 which teaches and discloses an apparatus and method for providing compensation for advertisement viewing and/or participation and/or for survey participation.

At step 1110, the user can take any desired action such as transmit comments or questions, including e-mail messages, to any candidate or group of candidates, make and/or transmit fundraising contributions or pledges to any candidate or group of candidates, transmit messages volunteering to serve as a campaign worker and/or fundraiser for the candidate or group of candidates, volunteer to post a lawn sign or window sign for a candidate or group of candidates, and/or transit a message containing any other messages and/or information to any candidate or candidates.

At step 1110, the user can also transmit a request to be notified regarding any new developments, information, polls, surveys, advertisements, scheduling of fundraisers, scheduling of events, and/or any other information, which may be posted at the central processing computer 10 regarding the upcoming election, any of the offices or positions which are to be filled by the election, and/or any information regarding and/or provided by any candidate or group of candidates. For example, a user may request to be notified by the central processing computer 10 if a candidate whom the user wants to support posts new campaign materials or the scheduling of a fundraiser.

At step 1111, the central processing computer 10 can receive and process the user's message or messages and perform any of the tasks required and/or requested thereby. In the case of a user's request to be notified upon the posting of information regarding an election, an office or position, or a candidate or candidates, the central processing computer 10 can also process and store this information at step 1111.

As noted above, at any time, any candidates), campaigns), campaign staff(s), political party or parties, group(s) or slate(s) of candidates, public elections administrators), private elections administrators, group(s), associations), organizations), and/or any other individual or entity, can access the central processing computer 10 and post information concerning any of the elections, offices, positions, candidates, and/or campaigns, etc. This information can be processed by the central processing computer 10 and can be stored in the database 10H and be made available for any processing and/or generation of any of the election reports and/or information described herein. Thereafter, the operation of the central processing computer 10 will proceed to step 1112.

At any time and/or upon the posting of any new developments and/or information regarding an election(s), an office or offices, a candidate(s), a campaign(s), and/or any other organizations or entities involved in, and/or related to, an election, an office, a candidate(s), and/or a campaign(s), the central processing computer 10, will process the information and determine if a notification request has been made pertaining to same.

If the central processing computer 10 determines that a notification request has been made, the central processing computer 10 will generate an appropriate message and/or election report, which can include a notification message and/or the information which the user has requested and/or which is the subject matter of the development and/or information, and transmit same to a user computer 20 or communication device associated with the requesting user. The election report and and/or information contained therein can be transmitted as an e-mail transmission, an e-mail message, an electronic transmission, a telephone message, a letter mail delivery, a telephone transmission, a facsimile transmission, a beeper or a pager message, and/or via any other notification means or method.

Upon receipt to the election report, the operation of the apparatus 100 can commence at, and proceed from, step 1108 described above.

The operation of the apparatus will thereafter cease at step 1112.

In this manner, the apparatus and method of the present invention can be utilized to provide a centralized election and/or campaign information center and/or clearinghouse for information and/or communications regarding and/or occurring between any of the herein-described users, individuals, and/or entities, described herein.

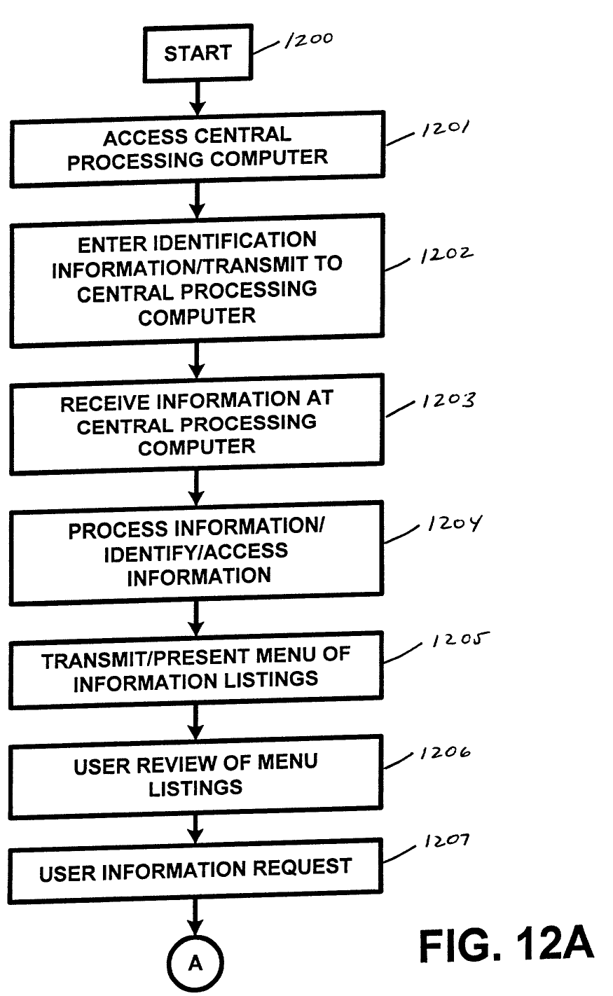

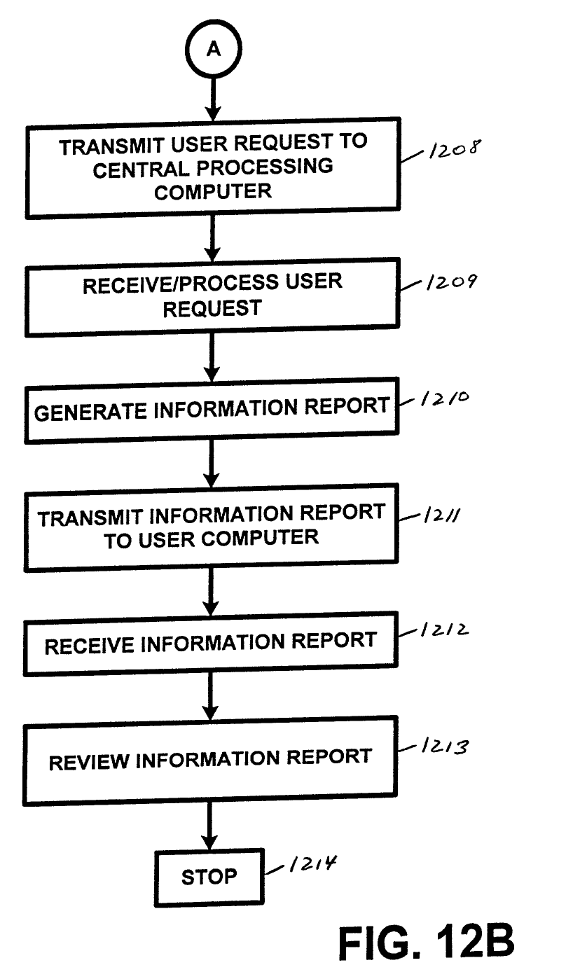

In another preferred embodiment, the apparatus and method of the present invention can be utilized in order to provide campaign management information and/or information for assisting in managing and/or conducting a campaign. FIGS. 12A and 12B illustrate another preferred embodiment method for utilizing the present invention, in flow diagram form.

In the embodiment of FIGS. 12A and 12B, it is envisioned that a candidate, a campaign manager, a campaign staff, a political party, and/or any other individual(s) and/or entity, will register their respective activities and/or efforts with the apparatus 100 and/or the central processing computer 10.

With reference to FIGS. 12A and 12B, the operation of the apparatus commences at step 1200. At step 1201, the user, individual, candidate, campaign manager, and/or campaign staff worker (hereinafter referred to as the “user”), can access the central processing 10 via the respective user computer 20 or campaign administrator computer 50. At step 1202, the user can enter identification information and/or campaign identification information and transmit same to the central processing computer 10.

At step 1203, the central processing computer 10 will receive and process the identification information. At step 1204, the central processing computer 10 will process the user or campaign identification information, identify the user or campaign and access any information from the database 10H which can or may pertain to the candidate, the campaign, and/or the election. At step 1205, the central processing computer will present to the user a menu of information item listings.

The menu items can contain any one or more of a number of subject areas, including, but not limited to, campaign, election, and/or election-related laws, rules, and/or regulations, filing requirements and/or filing forms regarding nomination petitions, financial disclosure forms, voter registration forms, absentee ballot forms, absentee ballots, election ballots, disclosure forms of any kind, and/or any other campaign and/or election forms and/or documents, voter registration lists, registered voter lists, preferred voter lists, political party information, and/or voter information of any kind.

The menu items can also contain event schedules, event listings, important dates, information regarding events, information regarding event information, polls, political polls, issue polls, surveys, issues pertinent to a campaign and/or an election, news, news regarding issues, developments regarding issues, and/or any other pertinent information.

The menu items can also contain information regarding fundraising, contributors, campaign contributors, fundraising filings of candidates, financial disclosure filings of candidates, fundraiser schedules, and/or any other pertinent information.

The menu items can also contain information regarding the activities, press releases, petition filings, financial disclosure filings, and/or other filings and/or activities of candidates and/or any other organizations.

The menu items can also contain information regarding any of the goods providers, products providers, and/or services providers, described herein regarding any of the campaign and/or related goods, products, and/or services.

The menu items can also contain any other information regarding any of the campaigns, elections, candidates, and/or organizations, described herein. The menu items can also include links and/or hyperlinks to any of the herein-described and/or related information.

At step 1206, the user can receive and/or review the menu items on his or her user computer 20. At step 1207, the user can request the information which he or she is interested in. The request can be for, or regarding, any of the information which is contained and/or related to the above-described menu items. For example, the user can request any one or more of a nominating petition, a voter list, information regarding polls, surveys, information regarding other candidates, information regarding events, event schedules, information regarding campaign related goods, products, and/or services, and/or any other information which may be useful to, and/or desired by, a candidate, a campaign, a campaign manager, and/or any other individual.

At step 1208, the user's request is transmitted to the central processing computer 10. At step 1209, the central processing computer 10 can receive and process the user's request. At step 1210, the central processing computer 10 will generate an information report which can contain the requested information and/or a link or links to the requested information. At step 1211, the information report will be transmitted to user computer 20 associated with the user. At step 1212, the user computer 20 will receive the information report. At step 1213, the user will review the information in the information report and utilize same in any appropriate manner. Thereafter, the operation of the apparatus 100 will cease at step 1214.

The information report, as well as any of the information transmitted to the user or the user computer 20, can also be transmitted as an e-mail transmission, an e-mail message, an electronic transmission, a telephone message, a letter mail delivery, a telephone transmission, a facsimile transmission, a beeper or a pager message, and/or via any other notification means or method.

In another preferred embodiment, the user can also, at step 1207, request to be notified regarding any new developments, information, polls, surveys, advertisements, scheduling of fundraisers, scheduling of events, and/or any other information, which may be posted at the central processing computer 10 regarding the upcoming election, any of the offices or positions which are to be filled by the election, and/or any information regarding and/or provided by any candidate, group of candidates, and/or any other information sources. The central processing computer 10 can receive and process the user's notification request.

As noted above, at any time, any candidate(s), campaign(s), campaign staff(s), political party or parties, group(s) or slate(s) of candidates, public elections administrator(s), private elections administrators, group(s), association(s), organization(s), and/or any other individual or entity, can access the central processing computer 10 and post any of the herein-described information. This information can be processed by the central processing computer 10 and can be stored in the database 10H and be made available for any processing and/or generation of any of the information reports and/or information described herein.

At any time and/or upon the posting of any of the new developments, information, polls, surveys, advertisements, scheduling of fundraisers, scheduling of events, and/or any other information, the central processing computer 10 will process the information and determine if a notification request has been made pertaining to same.

If the central processing computer 10 determines that a notification request has been made, the central processing computer 10 will generate an appropriate message and/or information report, which can include a notification message and/or the information which the user has requested and/or which is the subject matter of the development and/or information, and transmit same to a user computer 20 or communication device associated with the requesting user.

The information report and and/or information contained therein can be transmitted as an e-mail transmission, an e-mail message, an electronic transmission, a telephone message, a letter mail delivery, a telephone transmission, a facsimile transmission, a beeper or a pager message, and/or via any other notification means or method. The information report can also contain information reminding an individual, candidate, campaign, political party, and/or organization, to perform a task, take an action, and/or effect a required filing.

The present invention can also be utilized by a candidate, a campaign, and/or a political party, in order to ascertain a candidates standing in a poll or survey at any time. The candidate, campaign, or political party, can request that polls or surveys be performed by the apparatus 100 and/or by the central processing computer in any appropriate polling and/or surveying manner. The central processing computer 10 can be programmed to perform polls, poll taking, and/or surveys at any time, at a pre-determined time interval(s), and/or in any other appropriate and/or selected manner. In this regard, the central processing computer 10 can perform polls or surveys for a candidate and/or for any issues or areas of interest and make these polls or surveys available to a candidate, a campaign, and/or a political party.

The central processing computer 10 can also provide the results of a poll(s) or survey(s) when the latest information becomes available and/or at any other time. The polling information or survey information can also be provided to the respective candidate, campaign, and/or political party, as an e-mail transmission, an e-mail message, an electronic transmission, a telephone message, a letter mail delivery, a telephone transmission, a facsimile transmission, a beeper or a pager message, and/or via any other notification means or method.

In another preferred embodiment, the central processing computer 10 can maintain event schedules and/or calendars for any of the individuals, candidates, campaigns, political parties, and/or organizations, described herein. The central processing computer 10 can receive event scheduling information from any of the herein-described users, individuals, candidates, campaigns, political parties, and/or organizations, and/or any other third parties, who or which can utilize the apparatus 100. The central processing computer 10 can process any received event scheduling information, identify the individual(s), candidate(s), campaign(s), political party or parties, and/or organization(s), who or which may have an interest in the event, and update the schedule or calendar of the respective individual(s), candidate(s), campaign(s), political party, and/or organization(s), so as to include the event in their respective schedule(s) and/or calendar(s) of the respective individual(s), candidate(s), campaign(s), political party, and/or organization(s).

In another preferred embodiment, the apparatus 100 can be utilized in order to record and store financial transactions for, and/or campaign contributions, financial as well as non-financial and/or in-kind which are received by, an individual, a candidate, a campaign, a political party, and/or organization. The central processing computer 10 can process the stored financial transaction information and/or campaign contribution information in conjunction with financial disclosure requirements and generate financial disclosure report(s) for, or on behalf of, the individual, candidate, campaign, political party, and/or organization.

The central processing computer 10 can thereafter file the financial disclosure form with an appropriate public election administrator computer(s) 30 or the private election administrator computer(s) 40. The central processing computer 10 can also perform any other financial accounting processing routines in order to provide financial accounting services for, or on behalf of, the individual, candidate, campaign, political party, and/or organization.

In the above-described manner, the apparatus 100 can be utilized in order to provide an information clearinghouse for any or the campaign information and/or election information, and/or any other related information, described herein, which can be utilized in managing and/or conducting campaign activities.

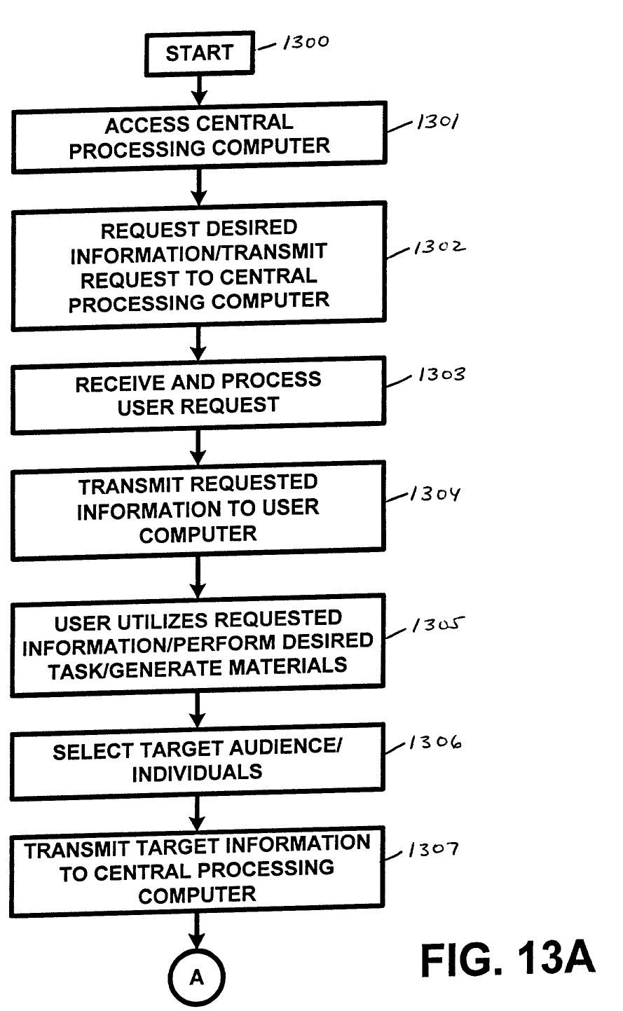

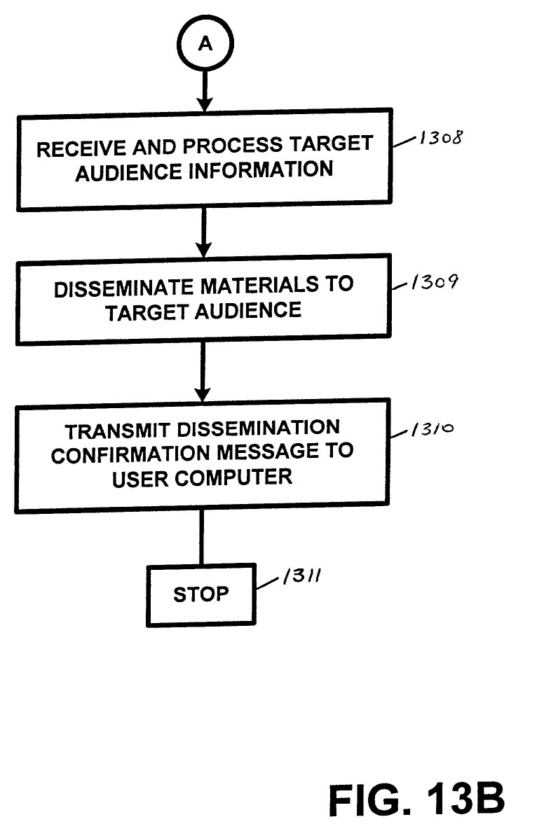

In another preferred embodiment, the apparatus and method of the present invention can be utilized in order to generate, produce, and/or disseminate, campaign materials, campaign literature, and/or press releases. FIGS. 13A and 13B illustrate another preferred embodiment method for utilizing the present invention, in flow diagram form.

With reference to FIGS. 13A and 13B, the operation of the apparatus 100 commences at step 1300. At step 1301, the user, individual, candidate, campaign manager, and/or campaign worker (hereinafter referred to as the “user”), can access the central processing computer 10. At step 1302, the user can request to obtain information needed for generating, designing, and/or producing campaign literature, campaign information, campaign materials, campaign mailings, and/or press releases (hereinafter referred to as the “materials”), and transmit the request to the central processing computer 10.

At step 1303, the central processing computer 10 will receive and process the user's request. At step 1304, the central processing computer 10 can transmit information, templates, document templates, literature templates, mailing templates, press release templates, and/or any other information which can assist the user in generating, designing, and/or producing, any of the herein-described and/or requested materials. At step 1305, the user can thereafter generate, design, and/or produce the materials. The materials can be produced and/or generated at the central processing computer 10. The materials can be text materials, audio materials, video materials, audio/video materials, and/or any combination thereof.

The materials can also be produced and/or generated at the user computer 20 and can be transmitted to the central processing computer 10. Thereafter, the materials can be stored at the central processing computer 10, at the user computer 20, or at both computers.

At step 1306, the user can select the individuals, voters, voter groups, groups of individuals and/or entities, organizations, associations, and/or the media, press, newspapers, radio stations, television stations, etc., (hereinafter referred to as the “target audience”), to whom the materials will be disseminated. For example, the user can select to have campaign literature disseminated and/or sent to voters enrolled in a certain political party or parties, have literature disseminated and/or sent to certain unions, trade associations, and/or the press, etc.

At step 1307, the user's audience selection information is transmitted to the central processing computer 10. At step 1308, the central processing computer 10 will process the user's audience selection and identify the members of the target audience and any correspondence information (i.e. mailing address, e-mail, telephone number, beeper or pager number) corresponding thereto. At step 1309, the central processing computer 10 will disseminate the materials to each of the members of the target audience. At step 1310, the central processing computer 10 can transmit a materials dissemination confirmation message to the user computer so as to confirm to the user that the materials have been disseminated. Thereafter, the operation of the apparatus 100 will cease at step 1311.

In the above described manner, the apparatus and method of the present invention can be utilized to generate, design, and/or produce campaign materials and/or campaign-related materials and disseminate same to a user selected target audience. The present invention can also be utilized in order to provide campaign materials which can include video clips, audio clips, and/or audio/video clips.

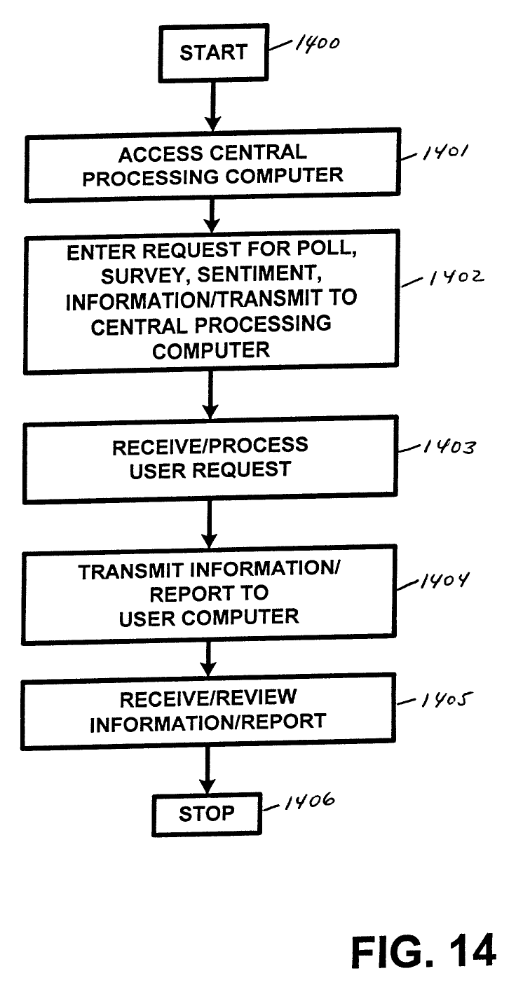

In another embodiment, the apparatus and method of the present invention can be utilized in order to perform polling and/or surveys and/or to make the results of the respective polls and/or surveys to any respective users of the present invention. FIG. 14 illustrates still another preferred embodiment method for utilizing the present invention, in flow diagram form.

With reference to FIG. 14, the operation of the apparatus 100 commences at step 1400. At step 1401, the user, individual, candidate, campaign manager, and/or campaign worker (hereinafter referred to as the “user”), can access the central processing computer 10. At step 1402, the user can request to obtain information regarding polls, surveys, and/or public sentiment (hereinafter referred to as “polls”), for or regarding, any issues which may be of interest to candidates and/or campaigns and/or which may be pertinent to an election, and transmit the request to the central processing computer 10.

At step 1403, the central processing computer 10 will receive and process the user's request. At step 1403, the central processing computer 10 will identify the poll, polls, survey, and/or surveys, which are of interest to the user. If the user requested that a poll or survey be performed, then the central processing computer will identify the poll or survey, perform the poll or survey and compile the results of same into a respective poll report or survey report.

The polls or surveys can be stored in the database 10H can be stored in the database 10H and/or can be obtained by the central processing computer from an external information source or provider, such as a pollster and/or survey taking entity. The polls and/or surveys can also be obtained from the respective external information sources described herein. If the poll, polls, survey, or surveys, already exist, then the central processing computer 10 will generate a respective poll report or survey report.

At step 1404, the central processing computer 10 can transmit information regarding the poll, polls, survey, or surveys, and/or the respective poll report or survey report, to the user computer 20. The poll report or survey report, as well as any of the information transmitted to the user or the user computer 20, can also be transmitted as an e-mail transmission, an e-mail message, an electronic transmission, a telephone message, a letter mail delivery, a telephone transmission, a facsimile transmission, a beeper or a pager message, and/or via any other notification means or method.

At step 1405, the user can review the information regarding the poll, polls, survey, or surveys, and/or the respective poll report or survey report, of interest. Thereafter, the operation of the apparatus 100 can cease at step 1406.

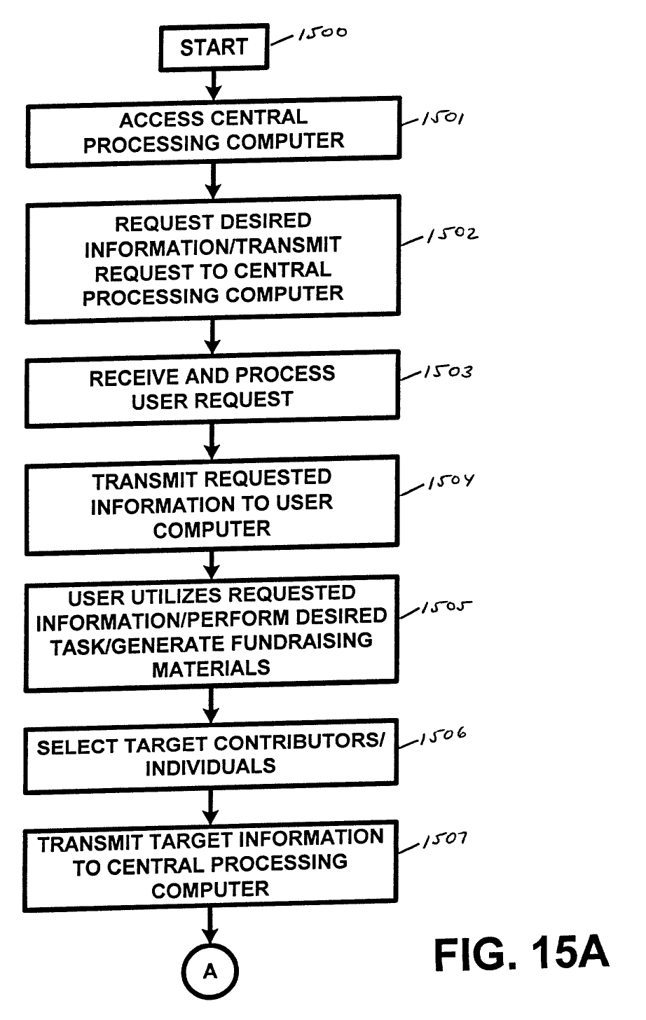

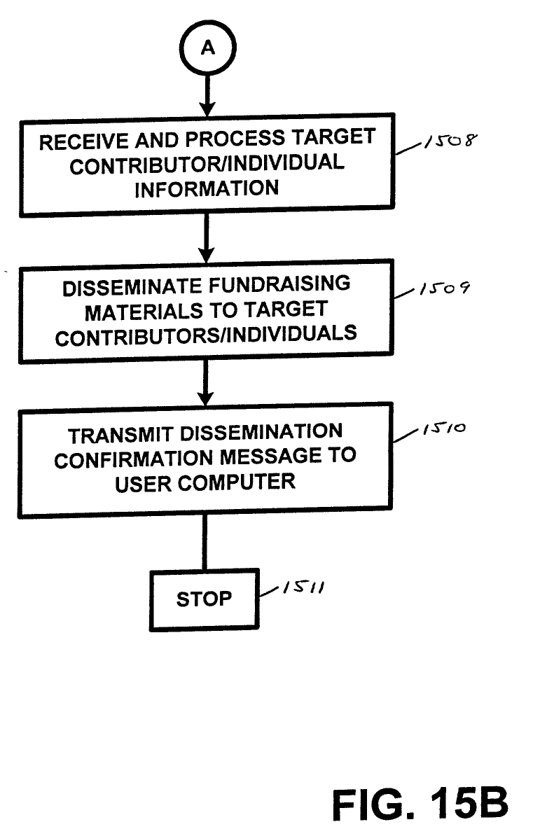

In another preferred embodiment, the apparatus and method of the present invention can be utilized to perform targeted information dissemination such as campaign fundraising and targeted fundraising activities. FIGS. 15A and 15B illustrate yet another preferred embodiment method for utilizing the present invention, in flow diagram form.

With reference to FIGS. 15A and 15B, the operation of the apparatus 100 commences at step 1500. At step 1501, the user, individual, candidate, campaign manager, and/or campaign worker (hereinafter referred to as the “user”), can access the central processing computer 10. At step 1502, the user can request to obtain information needed for generating, designing, and/or producing campaign fundraising materials and transmit the request to the central processing computer 10.

At step 1503, the central processing computer 10 will receive and process the user's request. At step 1504, the central processing computer 10 can transmit information, templates, and/or any other information which can assist the user in generating, designing, and/or producing, any of the herein-described and/or requested materials. At step 1505, the user can thereafter generate, design, and/or produce the fundraising materials. The materials can be produced and/or generated at the central processing computer 10. The materials can be text materials, audio materials, video materials, audio/video materials, and/or any combination thereof.

The materials can also be produced and/or generated at the user computer 20 and transmitted to the central processing computer 10. Thereafter, the materials can be stored at the central processing computer 10, at the user computer 20, or at both computers.

At step 1506, the user can select the individuals, voters, voter groups, groups of individuals and/or entities, organizations, and/or associations, and/or any other individuals and/or entities (hereinafter referred to as the “prospective contributors”, to whom the materials will be disseminated. For example, the user can select to have fundraising materials disseminated to certain constituents, associations, trade unions, and/or any other individual and/or organization.

At step 1507, the user's audience selection information is transmitted to the central processing computer 10. At step 1508, the central processing computer 10 will process the user's prospective contributor(s) selection and identify the these prospective contributors and any correspondence information (i.e. mailing address, e-mail, telephone number, beeper or pager number) associated therewith and/or corresponding thereto.

At step 1509, the central processing computer 10 will disseminate the materials to each of the prospective contributors. The materials transmitted to the prospective contributors or the computers or communication devices associated therewith, can also be transmitted as an e-mail transmission, an e-mail message, an electronic transmission, a telephone message, a letter mail delivery, a telephone transmission, a facsimile transmission, a beeper or a pager message, and/or via any other notification means or method.

At step 1510, the central processing computer 10 can transmit a materials dissemination confirmation message to the user computer so as to confirm to the user that the materials have been disseminated. The materials can contain information, links, and/or hyperlinks, to a candidate's or a campaign's correspondence location, web site, or web page, so that prospective contributor(s) can effect a financial contribution and/or a non-financial contribution(s) to the candidate or campaign via the materials. Thereafter, the operation of the apparatus 100 will cease at step 1511.

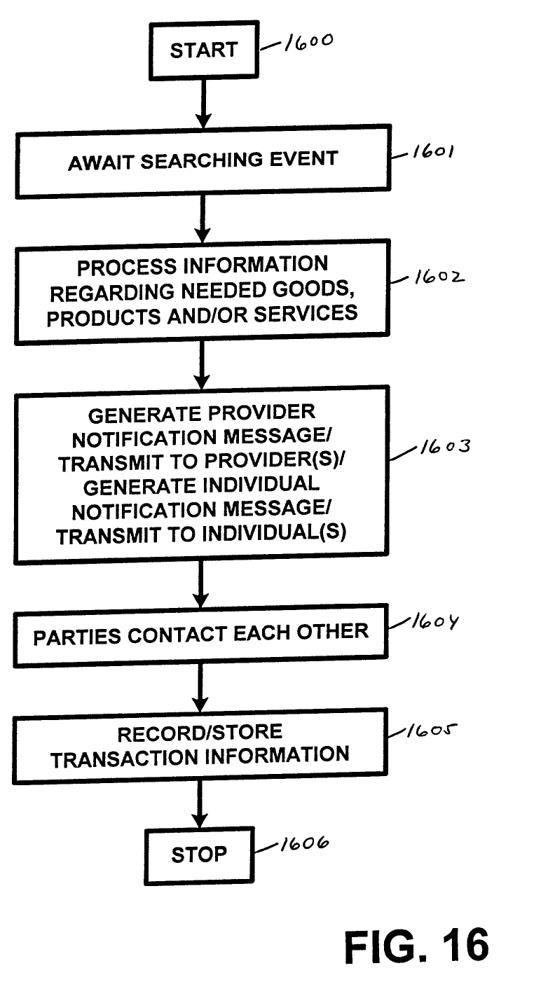

In another preferred embodiment, the apparatus and method of the present invention can be utilized in order to provide notification to an individual, a candidate, a campaign, and/or an organization, of the existence of, and/or the availability of, a provider of campaign goods, campaign products, and/or campaign services, and/or any other campaign-related goods, products, and/or services. FIG. 16 illustrates yet another preferred embodiment method for utilizing the present invention, in flow diagram form. In this manner, the apparatus 100 and method of the present invention can be utilized to identify and/or to locate providers of campaign goods, campaign products, and/or campaign services.

In the embodiment of FIG. 16, the various and/or respective providers of various campaign goods, products, and/or services can access the central processing computer 10 and post information regarding their respective campaign goods, products, and/or services. The campaign or campaign-related goods and/or products can include, but are not limited to, buttons, bumper stickers, literature, palm cards, advertisements, business cars, balloons, posters, signs, pens, pencils, and any other campaign-related goods and/or products and/or election-related goods and/or products.

The campaign or campaign-related services can include, but are not limited to, campaign management services, campaign consulting services, campaign advisory services, campaigning services, petition gathering services, printing services, publicity services, promotional services, advertising services, fundraising services, accounting services, legal services, staffing services, and/or any other campaign-related services and/or election-related services.

The information can include the types and/or kinds of campaign goods, products, and/or services, descriptions of the respective campaign goods, products, and/or services, cost and/or price information, conditions for sale of the respective goods and/or products and/or for performing the respective services, information regarding the suitability of, and/or the effectiveness of using the respective goods and/or products and/or the effectiveness of employing the respective services, and/or any other information for purchasing the respective goods and/or products, and/or for engaging the services of the respective providers.

The information which is posted by the respective providers can be stored in the database 10H. The information which is posted by the respective providers can also include data and/or information regarding any of the campaign goods and/or products which are typically employed in a campaign or promotional activities, specialized and/or custom tailored goods and/or products, and/or campaign provider services which are typically employed in a campaign or promotional activities as well as campaign consulting services, campaign analyst services, campaign strategy specialists, campaign advisory services, and/or any other specialized services.

The operation of the apparatus 100 will commence at step 1600. At step 1601, the central processing computer will await the occurrence of a searching event. The searching event can be any event which can result in the need for any individual, user, candidate, campaign, campaign staff member, political party, and/or organization, to obtain any of the respective goods, products, and/or services, which are offered by and/or which are provided by any of the respective providers described herein.

The searching event(s) can also include the posting of a request for any campaign and/or campaign-related goods, products, and/or services, which can be offered by, and/or which can be provided by, any of the respective providers described herein. The searching event(s) can also include the generation of any of the reports or messages described herein as serving to provide campaign management information, and/or a reminder to perform a campaign activity, a campaign function, a campaign-related filing, and/or any other campaign-related and/or election-related activity, which may result in the respective individual, user, candidate, campaign, campaign staff member, political party, and/or organization, needing and/or desiring to obtain and/or to utilize any of the goods, products and/or services, which are provided by any of the providers described herein.

The searching event can also include any other event or occurrence which can result in the need and/or the desirability for any of the goods, products, and/or services, which are offered by and/or provided by any of the providers described herein.

At step 1602, the central processing computer 10 will process the requested and/or needed goods, products, and/or services, in conjunction with the postings from the various providers in order to ascertain the existence and identities of the respective providers who or which can fulfill the needs or desires of respective individual, user, candidate, campaign, campaign staff member, political party, and/or organization.

At step 1603, the central processing computer 10 will generate a provider notification message and transmit same to each to each provider or to the providers who or which can fulfill the request, need, or desire, of the respective individual, user, candidate, campaign, campaign staff member, political party, and/or organization. The provider notification message can contain the identity and/or contact information regarding the respective individual, user, candidate, campaign, campaign staff member, political party, and/or organization. The provider notification message can also contain the price which the individual, user, candidate, campaign, campaign staff member, political party, and/or organization is willing to pay for the respective goods, products, and/or services.

The provider notification message, as well as any of the information transmitted to the provider or the provider computer 60, can also be transmitted as an e-mail transmission, an e-mail message, an electronic transmission, a telephone message, a letter mail delivery, a telephone transmission, a facsimile transmission, a beeper or a pager message, and/or via any other notification means or method.

At step 1603, the central processing computer 10 can also generate an individual, user, candidate, campaign, campaign staff member, political party, and/or organization, notification message and transmit same to the respective individual, user, candidate, campaign, campaign staff member, political party, and/or organization, or to the computer or communication device associated therewith. The individual, user, candidate, campaign, campaign staff member, political party, and/or organization, notification message can contain the identity and/or contact information for each of the providers included in the message.

The notification message can also contain the cost or price for the respective goods, products, and/or services. The individual, user, candidate, campaign, campaign staff member, political party, and/or organization, notification message, as well as any of the information transmitted to the user or the user computer 20, can also be transmitted as an e-mail transmission, an e-mail message, an electronic transmission, a telephone message, a letter mail delivery, a telephone transmission, a facsimile transmission, a beeper or a pager message, and/or via any other notification means or method.

Thereafter, at step 1604, the respective parties can contact each other and enter into any agreements and/or contracts related to the obtaining and/or the providing of the respective goods, products, and/or services. At step 1605, the central processing computer 10 can record any data and/or information regarding any transactions which may occur at step 1604 between the respective parties and store said data and/or information in the database 10H. Thereafter, the operation of the apparatus 100 will cease at step 1606.

In another preferred embodiment, the apparatus and method of the present invention can be utilized in order to provide notification to a provider(s) of campaign and/or campaign-related goods, products, and/or services, of the existence of a user, an individual, a candidate, a campaign, and/or an organization, who or which may be interested in and/or who or which may be in need of and/or desirous of obtaining and/or utilizing any of the respective goods, products, and/or services, which are provided by the respective provider(s).

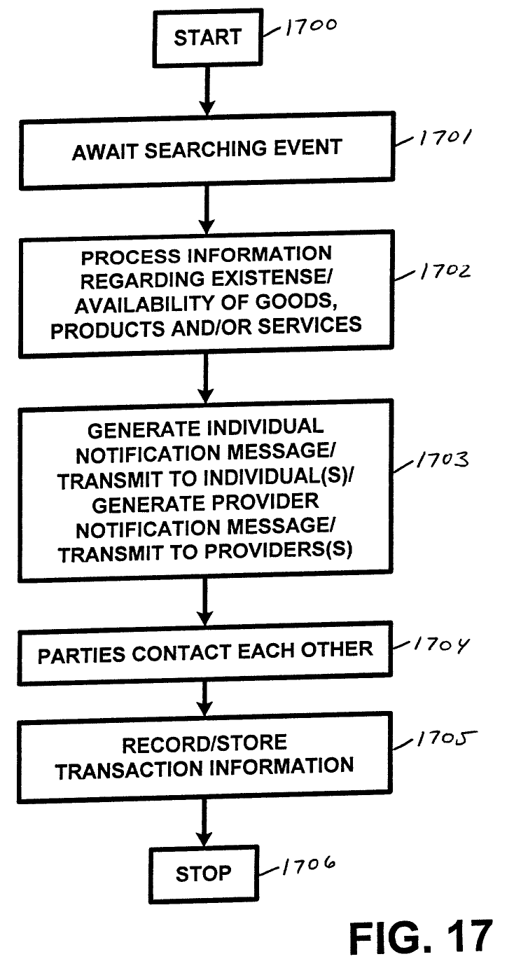

FIG. 17 illustrates yet another preferred embodiment method for utilizing the present invention, in flow diagram form. In this manner, the apparatus 100 and method of the present invention can be utilized to identify and/or to locate users, individuals, candidates, campaigns, and/or organization, who or which may need and/or desire to obtain campaign goods, campaign products, and/or campaign services, which are provided by any of the respective providers.

In the embodiment of FIG. 17, the various and/or respective individuals, users, candidates, campaigns, campaign staff members, political party or political parties, and/or organizations, can access the central processing computer 10 and post information regarding their requests, needs, and/or desires, for obtaining and/or for utilizing any respective campaign goods, products, and/or services.

The campaign or campaign-related goods and/or products can include, but are not limited to, buttons, bumper stickers, literature, palm cards, advertisements, business cars, balloons, posters, signs, pens, pencils, and any other campaign-related goods and/or products and/or election-related goods and/or products. The campaign or campaign-related services can include, but are not limited to, campaign management services, campaign consulting services, campaign advisory services, campaigning services, petition gathering services, printing services, publicity services, promotional services, advertising services, fundraising services, accounting services, legal services, staffing services, and/or any other campaign-related services and/or election-related services.

The information can include the types and/or kinds of campaign goods, products, and/or services, descriptions of the respective campaign goods, products, and/or services, the price or prices which the individuals, users, candidates, campaigns, campaign staff members, political party or political parties, and/or organizations, are willing to pay for the respective campaign goods, products, and/or services, conditions for purchasing the respective goods and/or products and/or for utilizing or employing the respective services, information regarding the expected suitability of, and/or the expected effectiveness of using the respective goods and/or products and/or the expected effectiveness of utilizing or employing the respective services, and/or any other information for purchasing the respective goods and/or products, and/or for engaging the services of the respective providers.

The information which is posted by the respective individuals, users, candidates, campaigns, campaign staff members, political party or political parties, and/or organizations, can be stored in the database 10H. The information which is posted by the respective individuals, users, candidates, campaigns, campaign staff members, political party or political parties, and/or organizations, can also include data and/or information regarding specialized requirements and/or custom requirements for the goods, products, and/or services, which are requested, needed, or desired, by the individuals, users, candidates, campaigns, campaign staff members, political party or political parties, and/or organizations.

The operation of the apparatus 100 will commence at step 1700. At step 1701, the central processing computer will await the occurrence of a searching event. The searching event can be any event which can result in the request, need, or desire, for any of the respective campaign goods, campaign products, and/or campaign services, by any of the respective individuals, users, candidates, campaigns, campaign staff members, political party or political parties, and/or organizations, described herein.

The searching event(s) can also include the posting of the availability of any campaign and/or campaign-related goods, products, and/or services, which can be offered by, and/or which can be provided by, any of the respective providers described herein. The searching event(s) can also include the generation of any of the reports or messages described herein as serving to provide campaign management information, and/or a reminder to perform a campaign activity, a campaign function, a campaign-related filing, and/or any other campaign-related and/or election-related activity, which may result in the respective individual, user, candidate, campaign, campaign staff member, political party, and/or organization, needing and/or desiring to obtain and/or to utilize any of the campaign and/or campaign-related goods, products and/or services, which are provided by any of the providers described herein.

The searching event can also include any other event or occurrence which can result in the need and/or the desirability for any of the goods, products, and/or services, which are offered by and/or provided by any of the providers described herein.

At step 1702, the central processing computer 10 will process the information regarding the existence of and/or the availability of the respective campaign and/or campaign-related goods, products, and/or services, in conjunction with the postings from the various individuals, users, candidates, campaigns, campaign staff members, political party or political parties, and/or organizations, in order to ascertain the existence and identities of the respective individuals, users, candidates, campaigns, campaign staff members, political party or political parties, and/or organizations, who or which may desire to obtain the respective campaign and/or campaign-related goods, products, and/or services.

At step 1703, the central processing computer 10 will generate an individual, user, candidate, campaign, campaign staff member, political party, and/or organization, notification message and transmit same to the respective individual, user, candidate, campaign, campaign staff member, political party, and/or organization, or to the computer or communication device associated therewith.

The individual, user, candidate, campaign, campaign staff member, political party, and/or organization, notification message can contain the identity and/or contact information for each of the providers included in the message. The notification message can also contain the cost or price for the respective goods, products, and/or services. The individual, user, candidate, campaign, campaign staff member, political party, and/or organization, notification message, as well as any of the information transmitted to the user or the user computer 20, can also be transmitted as an e-mail transmission, an e-mail message, an electronic transmission, a telephone message, a letter mail delivery, a telephone transmission, a facsimile transmission, a beeper or a pager message, and/or via any other notification means or method.

At step 1703, the central processing computer 10 can also generate a provider notification message and transmit same to each to each provider or to the providers who or which can fulfill the request, need, or desire, of the respective individual, user, candidate, campaign, campaign staff member, political party, and/or organization.

The provider notification message can contain the identity and/or contact information regarding the respective individual, user, candidate, campaign, campaign staff member, political party, and/or organization. The provider notification message can also contain the price which the individual, user, candidate, campaign, campaign staff member, political party, and/or organization is willing to pay for the respective goods, products, and/or services. The provider notification message, as well as any of the information transmitted to the provider or the provider computer 60, can also be transmitted as an e-mail transmission, an e-mail message, an electronic transmission, a telephone message, a letter mail delivery, a telephone transmission, a facsimile transmission, a beeper or a pager message, and/or via any other notification means or method.

Thereafter, at step 1704, the respective parties can contact each other and enter into any agreements and/or contracts related to the obtaining and/or the providing of the respective goods, products, and/or services. At step 1705, the central processing computer 10 can record any data and/or information regarding any transactions which may occur at step 1704 between the respective parties and store said data and/or information in the database 10H. Thereafter, the operation of the apparatus 100 will cease at step 1706.

In another preferred embodiment, the apparatus and method of the present invention can be utilized to conduct a poll, polls, a survey, or surveys, for any of the users, individuals, candidates, campaigns, political parties, and/or organizations.

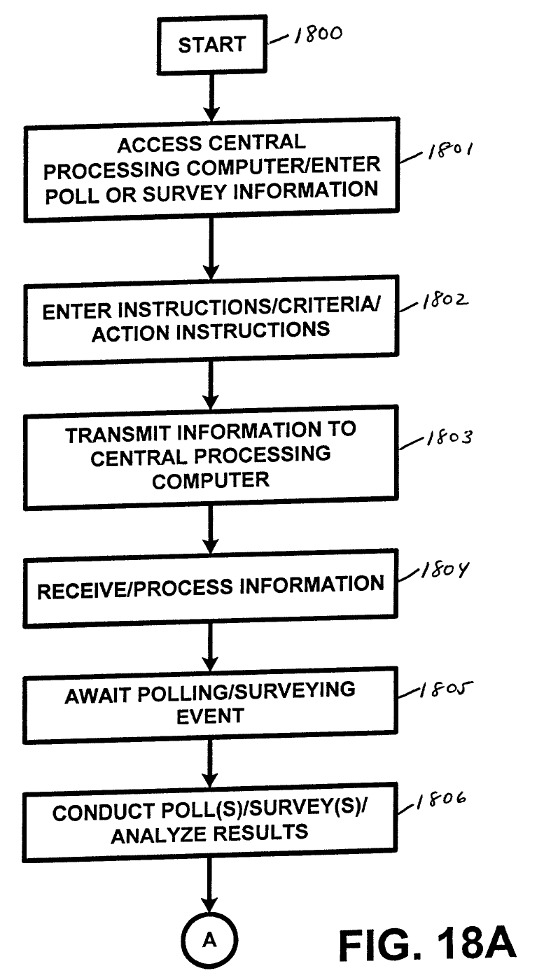

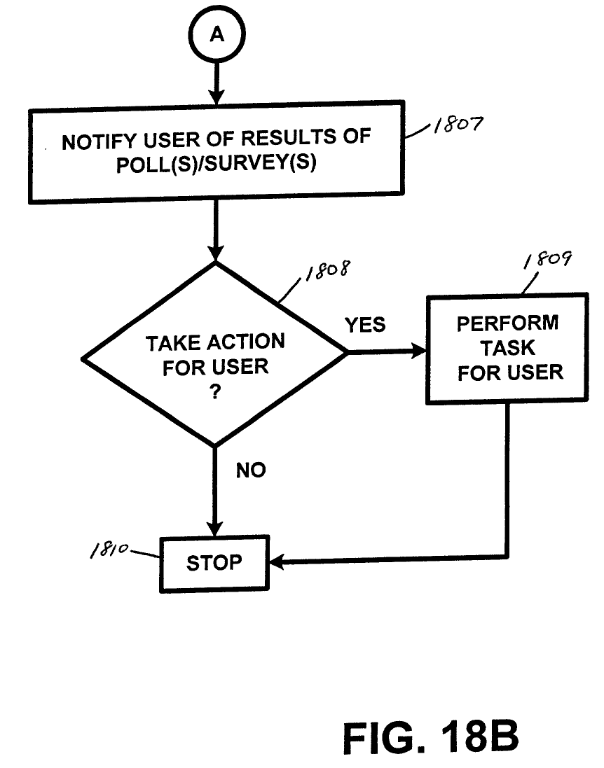

The apparatus and method of the present invention can be programmed to analyze the results of the respective poll, polls, a survey, or surveys, identify areas of weakness or vulnerability, and disseminate campaign materials to targeted voters or areas in order to attempt to overcome the weakness or vulnerability. FIGS. 18A and 18B illustrate another preferred embodiment method for utilizing the apparatus 100 and method of the present invention.

With reference to FIGS. 18A and 18B, the operation of the apparatus commences at step 1800. At step 1801, a respective user, individual, candidate, campaign, political party, and/or organization, accesses the central processing computer 10 via the user computer 20. At step 1801, the respective user, individual, candidate, campaign, political party, and/or organization, can enter the type of poll, polls, survey, or surveys (i.e. candidate approval, candidate popularity, issue sentiment, etc), which the respective user, individual, candidate, campaign, political party, and/or organization, would like to have polled or surveyed.

At step 1802, the respective user, individual, candidate, campaign, political party, and/or organization, can enter or request that multiple polls or surveys be performed. At step 1802, the respective user, individual, candidate, campaign, political party, and/or organization, can enter the frequency and/or other criteria for conducting poll, polls, survey, and/or surveys (i.e. at specific time intervals, at specific times during a campaign, after debates, after certain events and/or activities, after the issuance of certain press releases and/or the dissemination of campaign literature, after the taking of other polls or surveys, etc.).

At step 1802, the respective user, individual, candidate, campaign, political party, and/or organization, can also enter the action(s) which the respective user, individual, candidate, campaign, political party, and/or organization, desires that the central processing computer 10 take or perform on his, her, or its behalf. For example, the respective user, individual, candidate, campaign, political party, and/or organization, can program, or request that, the central processing computer 10 perform targeted campaign literature dissemination or transmissions to, certain voters, voter groups, election districts, election districts identified as being an area of concern or identified as being an are of weakness or vulnerability, order the shipping of campaign goods and/or products, order campaign services, campaign commercial programming, campaign advertisements, issue or disseminate press releases, and/or perform any other desired task or function for, or on behalf of, the respective user, individual, candidate, campaign, political party, and/or organization.

Any of the polls, surveys, campaign literature, campaign goods, products, and/or services, and/or other information and/or materials specified by the respective user, individual, candidate, campaign, political party, and/or organization, can be pre-selected and entered into the central processing computer 10 at any time.

At step 1803, all of the entered information and instructions can be transmitted to the central processing computer 10. At step 1804, the central processing computer 10 can receive and process the entered information and instructions. At step 1805, the central processing computer 10 will await the polling or surveying event.

At step 1806, the central processing computer 10, will conduct the poll, polls, survey, and/or surveys and analyze and process the results of the poll, polls, survey, and/or surveys. At step 1807, the central processing computer 10 can notify the respective user, individual, candidate, campaign, political party, and/or organization, of the results of the poll, polls, survey, and/or surveys.

At step 1808, the central processing computer 10 will determine if the results of the poll, polls, survey, and/or surveys, are such so as to require the central processing computer 10 to take any specified action and/or perform any specified task for, or on behalf of, the respective user, individual, candidate, campaign, political party, and/or organization. For example, the candidate could have instructed the central processing computer 10 to disseminate campaign literature via e-mail, automated telephone call messages, letter mail, and/or via any other method, to targeted voters or voting areas or election districts, in response to a low candidate popularity polling score.

If, at step 1808, it is determined that the central processing computer 10 is to perform a task or function for, or on behalf of, the candidate, that the operation of the apparatus 100 will proceed to step 1809 and the central processing computer 10 will perform the task or the function. Thereafter, the operation of the apparatus 100 will cease at step 1810 and the apparatus 100 and/or the central processing computer 10 will await the next the polling or surveying event. If, however, at step 1808, it is determined that the central processing computer 10 is not required, and/or does not have to, perform a task or function for, or on behalf of, the candidate, then the operation of the apparatus 100 will proceed directly to step 1810. As described above, at step 1810, the operation of the apparatus 100 will cease and the apparatus 100 and/or the central processing computer 10 will await the next the polling or surveying event.

In this manner, the apparatus 100 can perform programmed campaign and/or programmed campaigning functions or tasks for, or on behalf of, the respective users, individuals, candidates, campaigns, political party or political parties, and/or organizations, described herein.

In any and/or all of the embodiments described herein, the apparatus and method of the present invention can be utilized in order to bid for, and/or to auction off, any of the campaign and/or campaign-related goods, products, and/or services, described herein, and/or any other goods, products, and/or services, which can be utilized in a campaign and/or in an election. Applicant hereby incorporates by reference herein the subject matter and teachings of U.S. patent application Ser. No. 09/498,143 which teaches and discloses an apparatus and method for effectuating commerce in a network environment.

In any and/or all of the embodiments described herein, the apparatus and method of the present invention can also be utilized in order to provide recruitment services and/or to facilitate recruitment activities for, or regarding, any campaign and/or campaign-related positions and/or jobs. Applicant hereby incorporates by reference herein the subject matter and teachings of U.S. patent application Ser. No. 09/612,528 which teaches and discloses an apparatus and method for providing job searching services, recruitment services and/or recruitment-related services.

In another preferred embodiment, the apparatus and method of the present invention can be utilized in order to administer and/or manage financial accounts, and/or to transmit and/or receive payments and/or funds transfer, for, or on behalf of, any of the candidates, campaigns, providers, organizations, and/or any other users, of the present invention.

In another preferred embodiment, the apparatus and method of the present invention can also be utilized in order to perform on-line voting in any of the herein-described elections and/or campaigns. In this embodiment, any voter my vote in an election by casting his or her vote via the respective user computer 20. The vote can be transmitted to the central processing computer 10 and, thereafter, can be transmitted to the respective public election administrator computer 30 or private election administrator computer 40.

In another preferred embodiment, the vote can be transmitted directly to the respective public election administrator computer 30 or private election administrator computer 40, from the user computer 20.

In another preferred embodiment, the apparatus 100 and/or the central processing computer 10 can receive campaign contributions and/or campaign donations for, or on behalf of any of the candidates, campaigns, political parties, and/or organizations, described herein.

In another preferred embodiment, the apparatus and method of the present invention can be utilized in order to monitor the activities of registered voters and/or eligible voters during an election. The central processing computer 10 can monitor the individuals who have voted, determine and/or identity the individuals who have not yet voted and transmit a message to the user computer 20 or communication device associated with the individuals.

The message can be transmitted from any candidate, campaign, political party, or organization, and can include information reminding the individual or voter to vote and/or to information promoting, or requesting support and/or a vote(s), for a particular candidate, campaign, political party, or organization. In this manner, the apparatus 100 and method of the present invention can be programmed to promote voting in an election, promote or campaign for a candidate(s), campaign(s), political party or political parties, or organization(s), and/or to perform “get-out-the-vote” activities.

In another preferred embodiment, the apparatus 100 and/or the central processing computer 10 can administer and/or manage financial accounts for any of the users, candidates, campaigns, groups of candidates, political parties, public elections administrators, private elections administrators, campaign administrators and/or campaign workers, goods providers, products providers, service providers, external information sources, media entities, financial institutions, individuals, organizations, associations, political action committees, and/or any other entities, who or which utilize the apparatus 100 of the present invention. In this manner, the apparatus 100 and/or the central processing computer 10 can effect financial and/or monetary transfers to, from, and/or between, any of the financial accounts for any of the parties described herein, thereby providing a billing and payment clearing platform for any of the financial transactions which can be facilitated by, and/or which can occur in conjunction with use of, the apparatus and method of the present invention.

In any and/or all of the embodiments described herein, the apparatus and method of the present invention can be utilized as a clearinghouse for buying and selling campaign goods, campaign products, campaign services, campaign-related goods, campaign-related products, and/or campaign-related services.

In another preferred embodiment, the apparatus 100 and/or the central processing computer 10 can administer and/or manage financial accounts for any of the providers and/or clients described herein. In this manner, the apparatus 100 and/or the central processing computer 10 can effect financial and/or monetary transfers to, from, and/or between, any of the financial accounts for any of the parties described herein, thereby providing a billing and payment clearing platform for any of the financial transactions which can be facilitated by the apparatus and method of the present invention.

In any and/or all of the embodiments described herein, any of the operations, tasks and/or functions described herein can be implemented and/or executed by intelligent agents, software agents, and/or mobile agents.

The respective intelligent agent (s), software agent(s), mobile agent(s), (hereinafter referred to collectively as “intelligent agent” or “intelligent agents”) can be programmed and/or designed to act on behalf of any of the respective users, individuals, candidates, campaigns, political parties, organizations, elections administrators, providers, media entities, external information sources, financial institutions, and/or any other individuals and/or entities, described herein and/or otherwise, who or which utilize the apparatus 100 and methods of the present invention.

The intelligent agent can act on behalf of the respective party in various related interactions and/or other activities which are described as being performed herein and/or which may be incidental and/or related thereto. Therefore, the present invention also provides an agent-based apparatus and method for providing campaign information and/or campaign-related information.

Applicant hereby incorporates by reference herein the subject matter of the Agent Sourcebook A Complete Guide to Desktop Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

Any and/or all of the communications, as well as any of the data and/or information transmissions, which are described as occurring between any of the herein-described users, individuals, candidates, campaigns, administrators, providers, external information sources, and/or financial institutions, or the respective computers or communication devices associated therewith, can be encrypted so as to provide for secured communications and/or transmissions. In this manner, the present invention can provide for secured and/or confidential communications and/or transmissions between any of the respective parties who or which utilize the apparatus 100 and methods of the present invention. Applicant hereby incorporates by reference herein the subject matter and teachings of Applied Cryptography, second edition, Bruce Schneier, Wiley & Sons, 1996.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, bluetooth communication networks or systems, low earth orbiting satellite (LEOs) networks or systems, as well as in, or on any internets and/or intranets, the Internet, the World Wide Web, and any other suitable communication network or system.

The data and/or information, described as being stored in the database 10H and/or in any of the other databases described herein, can be continuously updated by any of the individuals and/or entities who or which utilize the apparatus 100 or methods of the present invention.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for providing campaign information, comprising:
a memory device for storing at least one of campaign information and campaign-related information;
a receiver for receiving a request for information regarding at least one of a candidate, a campaign and an election;
a processor for processing said request for information in conjunction with said at least one of campaign information and campaign-related information, wherein said processor generates an information report in response to said request for information; and
a transmitter for transmitting said information report to a communication device associated with an individual.

2. The apparatus of claim 1, wherein said information report contains information regarding at least one candidate, and further wherein said information report contains information regarding at least one of a candidate's name, profile, resume, credentials, platform, position on issues, campaign literature, campaign advertisements, campaign commercials, campaign polls, campaign surveys, and fundraising information.

3. The apparatus of claim 1, wherein said information report contains information regarding candidates in an election district.

4. The apparatus of claim 1, wherein said information report contains information regarding at least one of a campaign issue, a campaign commercial, a campaign advertisement, campaign literature, video information, text information, audio information, results of a poll, results of a survey, polling place information, polling time information, and a hyperlink to other information.

5. The apparatus of claim 4, wherein said apparatus provides compensation for at least one of viewing an advertisement, viewing a commercial, and participation in at least one of a poll and a survey.

6. The apparatus of claim 1, wherein said processor generates a notification message containing information regarding at least one of a new development, a campaign development, a scheduling of an event, and a scheduling of a fundraiser.

7. A method for providing campaign information, comprising:
storing at least one of campaign information and campaign-related information;
receiving a request for information regarding at least one of a candidate, a campaign and an election;
processing said request for information in conjunction with said at least one of campaign information and campaign-related information;
generating an information report in response to said request for information; and
transmitting said information report to a communication device associated with an individual.

8. An apparatus for providing campaign information and/or campaign-related information, comprising:
a memory device for storing campaign management information;
a receiver for receiving a request for campaign management information;
a processor for processing said request for campaign management information in conjunction with said campaign management information stored in said memory device, wherein said processor generates an information report containing at least one of campaign management information and an link to campaign management information; and
a transmitter for transmitting said information report to a communication device associated with an individual.

9. The apparatus of claim 8, wherein said information report contains a menu of campaign management information, and further wherein said menu contains information regarding at least one of a campaign, an election, election-related laws, rules, and/or regulations, filing requirements, filing forms, nomination petitions, financial disclosure forms, financial disclosure filing deadlines, voter registration forms, absentee ballot forms, absentee ballots, election ballots, voter registration lists, registered voter lists, preferred voter lists, event schedules, event information, polls, political polls, issue polls, surveys, issues pertinent to a campaign and/or an election, news, news regarding issues, developments regarding issues, fundraising, contributors, campaign contributors, fundraising filings of candidates, financial disclosure filings of candidates, fundraiser schedules, press releases, petition filings, financial disclosure filings, goods providers, products providers, services providers, and political party information.

10. The apparatus of claim 1, wherein said apparatus can be at least one of programmable and self-activating.

11. The apparatus of claim 1, wherein said apparatus can be utilized to provide at least one of the bidding for and the auctioning off of at least one of campaign goods, campaign products, and campaign services.

12. The apparatus of claim 1, wherein said apparatus can be utilized to provide recruitment services.

13. The apparatus of claim 1, wherein said apparatus can be utilized to provide at least one of administer and manage financial accounts.

14. The apparatus of claim 1, wherein said apparatus can be utilized to provide on-line voting services.

15. The apparatus of claim 1, wherein said apparatus can be utilized to receive at least one of campaign contributions and campaign donations for at least one of a candidate, a campaign, a political party and an organization.

16. The apparatus of claim 1, wherein said apparatus can be utilized to monitor the activities of at least one of registered voters and eligible voters during an election.

17. The apparatus of claim 1, wherein said apparatus can be utilized as a clearinghouse for at least one of buying and selling at least one of campaign goods, campaign products, and campaign services.

18. The apparatus of claim 1, wherein said apparatus can be utilized in conjunction with at least one of intelligent agents, software agents, and mobile agents.

19. The apparatus of claim 1, wherein said apparatus can be utilized at least one of on and over the Internet, the World Wide Web, a communication network, a telecommunication network, a satellite communication network, a telephone communication network, a radio communication network, a digital communication network, a digital satellite communication network, a personal communications services network, a cable television network, a broadband communication network, a bluetooth communication network, a low earth orbiting satellite (LEOs) network, an intranet, and a combination of same.

20. The apparatus of claim 1, wherein at least one of a communication and a transmission occurring in conjunction with use of said apparatus is at least one of an e-mail transmission, an e-mail message, an electronic transmission, a telephone message, a letter mail delivery, a telephone transmission, a facsimile transmission, a beeper message, and a pager message.
